(19) United States
(12) Patent Application Publication
(10) Pub. No.: US 2015/0373269 A1
(43) Pub. Date: Dec. 24, 2015

(54) PARALLAX FREE THIN MULTI-CAMERA SYSTEM CAPABLE OF CAPTURING FULL WIDE FIELD OF VIEW IMAGES

(71) Applicant: QUALCOMM Incorporated, San Diego, CA (US)

(72) Inventor: Thomas Wesley Osborne, San Diego, CA (US)

(21) Appl. No.: 14/743,818

(22) Filed: Jun. 18, 2015

Related U.S. Application Data
(60) Provisional application No. 62/015,329, filed on Jun. 20, 2014.
(60) Provisional application No. 62/057,938, filed on Sep. 30, 2014.
(60) Provisional application No. 62/073,856, filed on Oct. 31, 2014.

(51) Int. Cl. H04N 5/232; H04N 5/225

(52) U.S. Cl. CPC H04N 5/23238; H04N 5/2258; H04N 5/2253; H04N 5/2254

(57) ABSTRACT

Methods and systems for producing wide field of view field-of-view images are disclosed. In some embodiments, an imaging system includes a front camera having a first field-of-view (FOV) in a first direction and an optical axis that extends through the first FOV, a back camera having an optical axis that extends through the first FOV, a plurality of side cameras disposed between the front camera and the back camera, a back light re-directing reflective mirror component disposed between the back camera and plurality of side cameras, the back light re-directing reflective mirror component further disposed perpendicular to the optical axis of the back camera, and a plurality of side light re-directing reflective mirror components, each of the plurality of side cameras positioned to receive light re-directed reflected from one of the plurality of light redirecting reflective mirror components.

### CROSS REFERENCE TO RELATED APPLICATIONS

The present application claims the benefit under 35 U.S.C. §119(e) of U.S. Provisional Patent Application No. 62/057,938, filed on Sep. 30, 2014, entitled “PARALLAX FREE THIN CAMERA WITH CENTRAL EIGHT SIDED PRISM AND EIGHT CAMERAS,” U.S. Provisional Patent Application No. 62/015,319, filed on Jun. 20, 2014, entitled “MULTI-CAMERA SYSTEM USING FOLDED OPTICS FREE FROM PARALLAX AND TILT ARTIFACTS,” and U.S. Provisional Patent Application No. 62/073,856, filed on Oct. 31, 2014, entitled “ARRAY CAMERA WITH IMAGE STABILIZATION,” the contents of which are hereby incorporated by reference herein.

### TECHNICAL FIELD

The present disclosure relates to imaging systems and methods that include a multi-camera system. In particular, the disclosure relates to systems and methods for capturing wide field of view images in a thin form factor.

### BACKGROUND

Many mobile devices, such as mobile phones and tablet computing devices, include cameras that may be operated by a user to capture still and/or video images. Because the imaging systems are typically designed to capture high-quality images, it can be important to design the cameras or imaging systems to be free or substantially free of parallax. Moreover, it may be desired for the imaging system to capture an image of a wide field of view scene where the captured image is parallax free or substantially parallax free. Imaging systems may be used to capture various fields of view of a scene from a plurality of locations near a central point. However, many of these designs involve images with a large amount of parallax because the fields of view originate from various locations and not from a central point.

### SUMMARY

An example of one innovation includes an imaging system that includes an optical component with four, eight or more cameras. The optical component can include at least four, eight or more light redirecting reflective mirror surfaces. The at least four cameras are each configured to capture one of a plurality of partial images of a target scene. Each of the at least four cameras have an optical axis, a lens assembly, and an image capture device such as an image sensor, array of sensors, photographic film and etc. (hereafter collectively referred to as an image sensor or sensor). The optical axis is aligned with a corresponding one of the at least four light redirecting reflective mirror surfaces of the optical component. The lens assembly is positioned to receive light representing one of the plurality of partial images of the target scene redirected from the corresponding one of the at least four light redirecting reflective mirror surfaces. The image sensor receives the light after passing of the light through the lens assembly.

An example of another innovation includes a method of capturing an image substantially free of parallax includes receiving light, splitting light, redirecting each portion of the light, and capturing an image for each of at least four cameras. In some embodiments of this innovation, light that represents a target image scene is essentially received through a virtual entrance pupil made up of a plurality of virtual entrance pupils associated with each camera and mirror surface pairs within the camera system. Received light is split into four or eight portions via at least four or eight light redirecting reflective mirror surfaces. Each portion of the light is redirected towards a corresponding camera, where each camera-mirror pair are positioned to capture image data through a virtual camera entrance pupil.

An example of another innovation includes an imaging system, the imaging system including means for redirecting light, a plurality of capturing means having an optical axis, focusing means, and image sensing means, means for receiving image data, and means for assembling the image data. In some embodiments of this innovation, the means for redirecting light directs light from a target image scene in at least four directions. A plurality of capturing means each have an optical axis aligned with a virtual optical axis of the imaging system and intersecting with a point common to at least one other optical axis of another of the capturing means, focusing means positioned to receive, from the means for redirecting light, a portion of the light redirected in one of the at least four directions, and image sensing means that receives the portion of the light from the focusing means. The means for receiving image data may include a processor coupled to memory. The means for assembling the image data into a final image of the target image scene includes a processor configured with instructions to assemble multiple images into a single (typically larger) image.

An example of another innovation includes a method of manufacturing an imaging system includes providing an optical component, positioning at least four cameras, aligning an optical axis of the camera, further positioning the camera, providing an image sensor, and positioning the optical component. In some embodiments of this innovation, an optical component is provided that includes at least four light redirecting surfaces. At least four cameras are positioned around the optical component. Each camera of the at least four cameras is configured to capture one of a plurality of partial images of a target scene. The at least four cameras that are positioned include, for each camera, aligning an optical axis of the camera with a corresponding one of the at least four light redirecting surfaces of the optical component, further positioning the camera such that the optical axis intersects at least one other optical axis of another of the at least four cameras at a point located along a virtual optical axis of the imaging system, and providing an image sensor that captures one of the plurality of partial images of the target scene.

### BRIEF DESCRIPTION OF THE DRAWINGS

The disclosed aspects will hereinafter be described in conjunction with the appended drawings and appendices, provided to illustrate examples and not to limit the disclosed aspects. The reference numbers in each figure apply only to that figure.

FIG. 1A illustrates an example of a top view of an embodiment of an eight camera imaging system.

FIG. 1B illustrates an example of a top view of an embodiment of an eight camera imaging system.

FIG. 1C illustrates an example of a top view of an embodiment of a four camera imaging system.

FIG. 2A illustrates an example of a side view of an embodiment of a portion of a wide field of a multi-camera configuration including a central camera and a first camera.

FIG. 2B illustrates an example of a side view of an embodiment of a portion of a wide field of view multi-camera configuration that replaces the single central camera of FIG. 1B.

FIG. 3A illustrates a schematic of two cameras of an embodiment of a multiple camera configuration.

FIG. 3B illustrates a schematic of two cameras of an embodiment of a multiple camera configuration.

FIG. 4 illustrates an embodiment of a camera shown in FIGS. 1A-3B and FIGS. 5-6 and illustrates positive and negative indications of the angles and distances for FIGS. 1A-3B and FIGS. 5-6.

FIG. 5 illustrates an embodiment of side view cross-section of the eight camera system.

FIG. 6 illustrates an embodiment of a side view cross-section of a four camera imaging system.

FIG. 7A shows the top view of a reflective element that can be used as the multi mirror system 700a of FIG. 1A.

FIG. 7B illustrates a side view of an embodiment of a portion of an eight camera configuration.

FIG. 8 illustrates a cross-sectional view of cameras 114a and 116b of FIG. 5 with a folded optics camera structure for each camera.

FIG. 9 illustrates a cross-sectional side view of an embodiment of a folded optic multi-sensor assembly.

FIG. 10 illustrates an example of a block diagram of an embodiment of an imaging device.

FIG. 11 illustrates blocks of an example of a method of capturing a target image.

### DETAILED DESCRIPTION

### A. Introduction

Implementations disclosed herein provide examples of systems, methods and apparatus for capturing wide field of view images with an imaging system that may fit in a thin form factor and that is parallax free or substantially parallax free. Aspects of various embodiments relate to an arrangement of a plurality of cameras (also referred to herein as a multi-camera system) exhibiting little or no parallax artifacts in the captured images. The arrangement of the plurality of cameras captures wide field of images, whereby a target scene being captured is partitioned into multiple images. The images are captured parallax free or substantially parallax free by designing the arrangement of the plurality of cameras such that they appear to have the same common real or virtual entrance pupil. The problem with some designs is they do not have the same real or virtual common entrance pupil and thus may not parallax free or, stated another way, free of parallax artifacts.

Each sensor in the arrangement of the plurality of cameras receives light from a portion of the image scene using a corresponding light redirecting light reflective mirror component (which is sometimes referred to herein as “mirror” or “mirror component”), or a surface equivalent to a mirror reflective surface. Accordingly, each individual mirror component and sensor pair represents only a portion of the total multi-camera system. The complete multi-camera system has a synthetic aperture generated based on the sum of all individual aperture rays. In any of the implementations, all of the cameras may be configured to automatically focus, and the automatic focus may be controlled by a processor executing instructions for automatic focus functionality.

In various embodiments, the multi-camera system includes four or eight or more cameras, each camera arranged for capturing a portion of a target scene such that eight or four or more or less portions of an image may be captured. The system includes a processor configured to generate an image of the scene by combining all or a portion of the eight or four or more or less portions of the image. In some embodiments, eight cameras (or a plurality of cameras) can be configured as two rings or radial arrangements of four cameras each, a virtual center camera formed by cooperation of the four cameras in the first ring, wherein the four cameras of the second ring cameras also capture images from the point of view of the virtual center camera. A plurality of light redirecting reflective mirror components are configured to redirect a portion of incoming light to each of the eight cameras for the eight camera configuration or each of the four cameras for each of a the four camera configuration. The portion of incoming light from a target scene can be received from areas surrounding the multi-camera system by the plurality of light redirecting reflective mirror components. In some embodiments, the light redirecting reflective mirror components may comprise a plurality of individual components, each having at least one light redirecting reflective mirror component. The multiple components of the light redirecting reflective mirror component may be coupled together, coupled to another structure to set their position relative to each other, or both.

As used herein, the phrase “parallax free images” (or the like) refers also to effectively or substantially parallax free images, and “parallax artifact free images” (or the like) refers also to effectively or substantially parallax artifact free images, wherein minimally acceptable or no visible parallax artifacts are present in final images captured by the system.

As an example, cameras systems designed to capture stereographic images using two side-by-side cameras are examples of cameras systems that are not parallax free. One way to make a stereographic image is to capture images from two different vantage points. Those skilled in the art may be aware it may be difficult or impossible, depending on the scene, to stitch both stereographic images together to get one image without having some scene content duplicated or missing in the final stitched image. Such artifacts are provided as examples of parallax artifacts. Further, those skilled in the art may be aware that if the vantage points of the two stereographic cameras are moved together so that both look at the scene from one vantage point it should then be possible to stitch the images together in such a way parallax artifacts are not observable.

For parallax free images, when two or more images are stitched together image processing is not used to alter the images by adding content or removing content from the images or the final stitched together image.

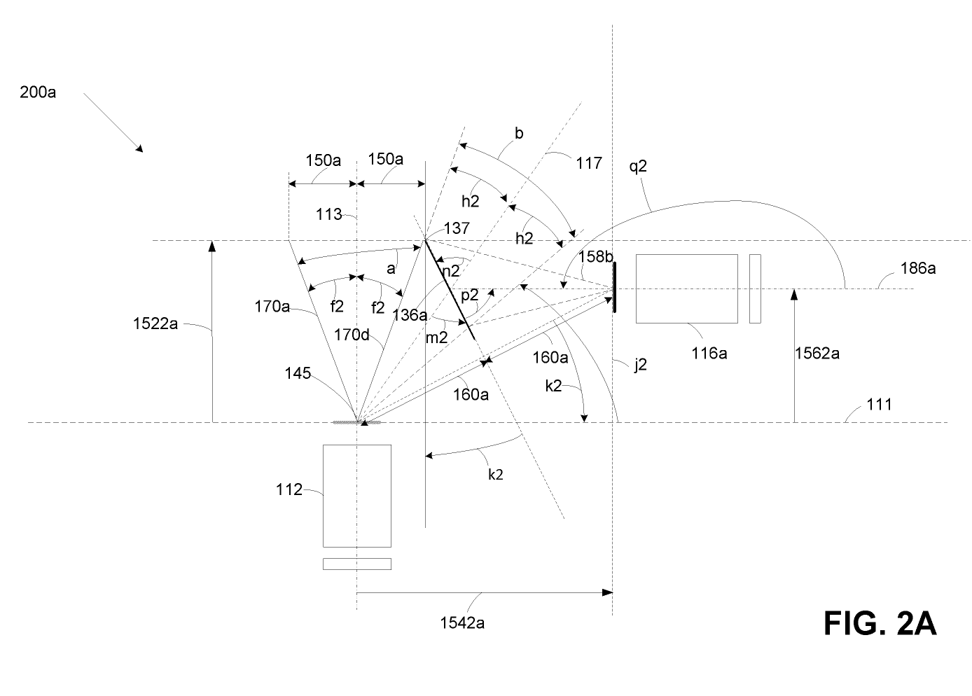

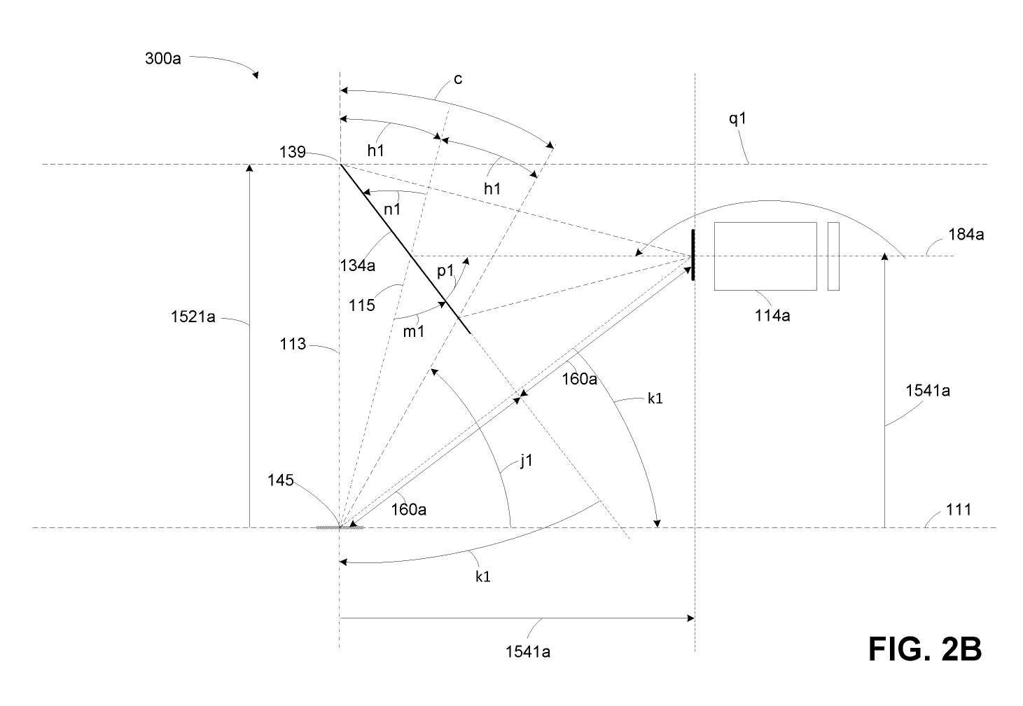

To produce parallax free images, a single lens camera can be rotated about a stationary point located at the center point of its entrance pupil while capturing images in some or all directions. These images can be used to create a wide field of view image showing wide field of view scene content surrounding the center point of the entrance pupil of a virtual center camera lens of the system. The virtual center camera of the multi-camera system will be further described below with respect to FIG. 2A. These images may have the added property of being parallax free and/or parallax artifact free. Meaning, for example, the images can be stitched together in a way where the scene content is not duplicated in the final wide field of view image and or the scene content may not be missing from the final stitched wide field of view image and or have other artifacts that may be considered to be parallax artifacts.

A single camera can be arranged with other components, such as light redirecting (for example, reflective or refractive) mirror components, to appear as if its entrance pupil center most point is at another location (that is, a virtual location), than the center most point of a the actual real camera's entrance pupil that is being used. In this way, two or more cameras with other optical components, such as light redirecting reflective mirror components for each camera, can be used together to create virtual cameras that capture images that appear to be at a different vantage point; that is, to have a different entrance pupil center most point located at a virtual location. In some embodiments it may be possible to arrange light redirecting reflective mirror component associated with each respective camera so that two or more cameras may be able to share the same center most point of each cameras virtual camera entrance pupil.

It can be very challenging to build systems with sufficient tolerance for two or more virtual cameras to share the exact same center most point of each cameras respective virtual camera entrance pupil. It may be possible given the pixel resolutions of a camera system and or the resolution of the lenses to have the virtual optical axis of two or more virtual cameras either intersect or come sufficiently close to intersecting each other near or around the center most point of a shared entrance pupil so that there is little or no parallax artifacts in the stitched together images or, as the case may be, the stitched together images will meet requirements of having less than a minimal amount of parallax artifacts in the final stitched together images. That is, without using special software to add content or remove content or other image processing to remove parallax artifacts, one would be able to take images captured by such cameras and stitch these image together so they produce a parallax free wide field of view image or meeting requirements of a minimal level of parallax artifacts. In this context one may use the terms parallax free or effectively parallax free based on the system design having sufficient tolerances.

Herein, when the terms parallax free, free of parallax artifacts, effectively parallax free or effectively free of parallax artifacts is used, it is to be understood that the physical realities may make it difficult or nearly impossible to keep physical items in the same location over time or even have the property of being exactly the same as designed without using tolerances. The realities are things may change in shape, size, position, relative position to possible other objects across time and or environmental conditions. As such, it is difficult to talk about an item or thing as being ideal or non-changing without assuming or providing tolerance requirements. Herein the terms such as effectively parallax free shall mean and be taken to mean the realities are most physical items will require having tolerances to where the intended purpose of the assembly or item is being fulfilled even though things are not ideal and may change over time. The terms of parallax free, free of parallax artifacts, effectively parallax free or effectively free of parallax artifacts with or without related wording should be taken to mean that it is possible to show tolerances requirements can be determined such that the intended requirements or purpose for the system, systems or item are being fulfilled.

In the following description, specific details are given to provide a thorough understanding of the examples. However, the examples may be practiced without these specific details.

### B. Overview of Example Four and Eight Camera Systems

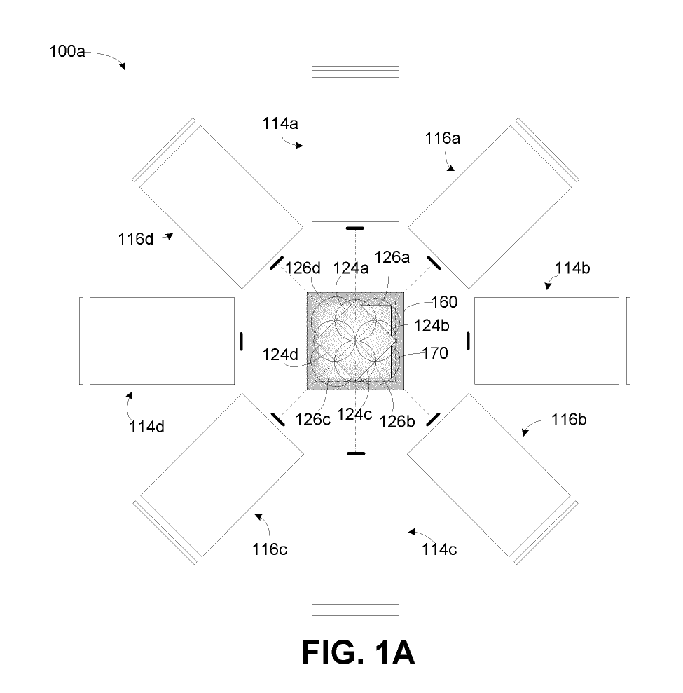

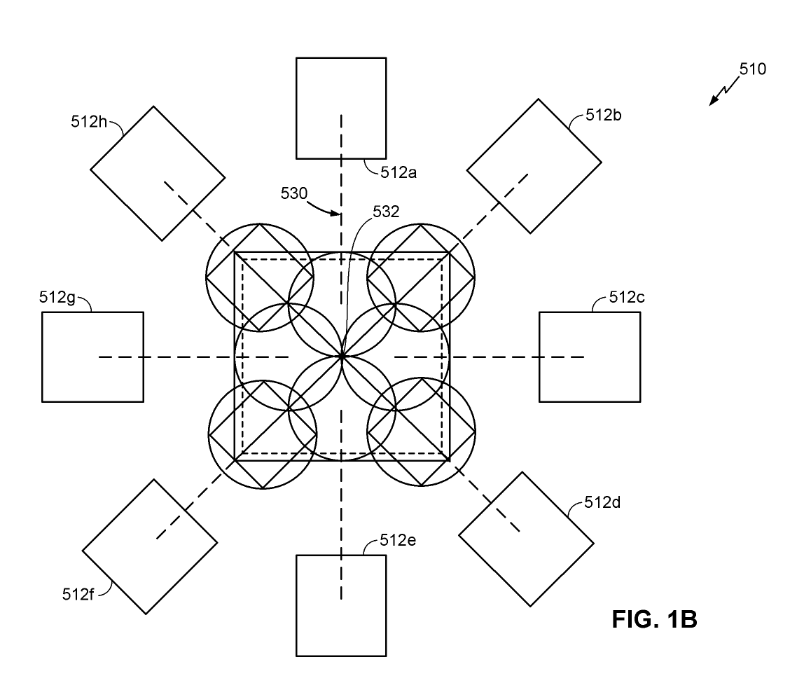

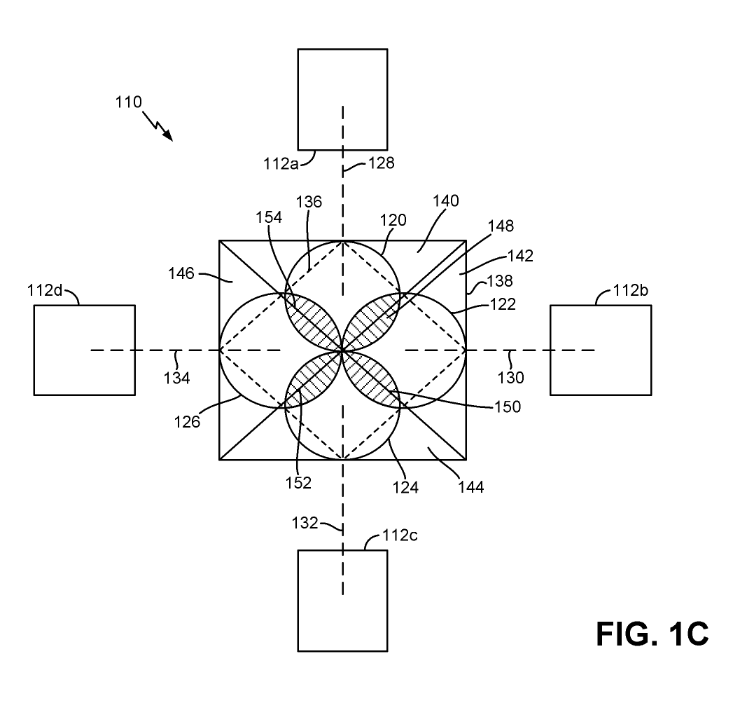

FIG. 1A illustrates an example of a top view of an embodiment of an eight camera imaging system 100a including first ring of cameras 114a-d and a second camera 116a-d that will be further described herein. The wide field of view camera configuration 100a also comprises at least several light redirecting reflective mirror components 124a-d that correspond to each of the cameras 114a-d in the first ring of cameras. Further, the wide field of view camera configuration 100a also comprises at least several light redirecting reflective mirror components 126a-d that correspond to each of the cameras 116a-d in the first ring of cameras. For instance, the light redirecting reflective mirror component (“mirror”) 124a corresponds to the camera 114a, and mirror 126a corresponds to the camera 116a. The mirrors 124a-d and 126a-d reflect incoming light towards the entrance pupils of each of the corresponding cameras 114a-d and 116a-d. In this embodiment, there is a mirror corresponding to each camera. The light received by the first ring of four cameras 114a-d and the second ring of four cameras 116a-d from a mosaic of images covering a wide field of view scene is used to capture an image as described more fully below with respect to FIGS. 1-3, 5 and 6. Although described in terms of mirrors, the light redirecting reflective mirror components may reflect, refract, or redirect light in any manner that causes the cameras to receive the incoming light.

The component 160, the dashed square line 150 and the elliptic and circular lines will be further described using FIGS. 2-8 herein.

The full field of view of the final image after cropping is denoted by dashed line 170 over component 160. The shape of the cropped edge 170 represents a square image with an aspect ratio of 1:1. The cropped image 170 can be further cropped to form other aspect ratios.

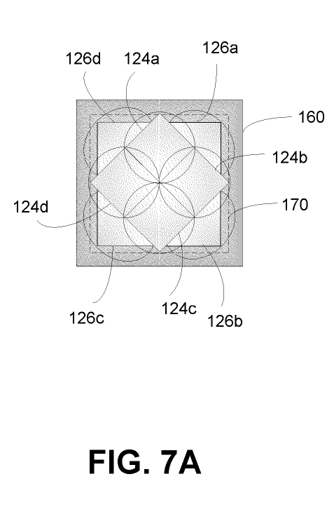

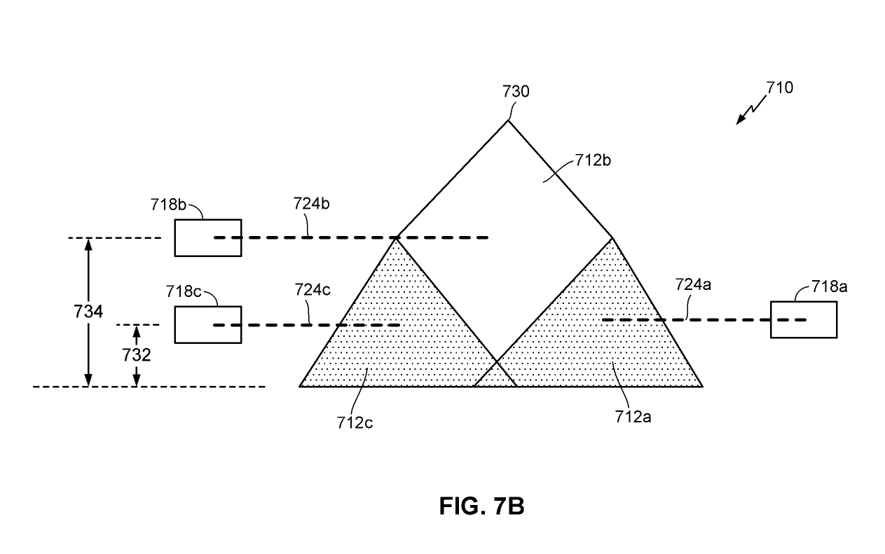

FIG. 1B illustrates a top view of an embodiment of an eight camera configuration 510. A central reflective element 532 can have a plurality of reflective surfaces which can be a variety of optical elements, including but not limited to one or more mirrors or as illustrated here, a prism. In some embodiments, a camera system has eight (8) cameras 512a-h, each camera capturing a portion of a target image such that eight image portions may be captured. The system includes a processor configured to generate a target image by combining all or a portion of the eight image portions, described further in reference to FIG. 7A. As illustrated in FIG. 1B, the eight cameras 512a-h can be configured as two sets of four (4) cameras, four of the cameras 512a, 512c, 512e, 512g collectively forming a virtual central camera, and the other four cameras 512b, 512d, 512f, 512h are used to create a wider field of view camera. The central reflective element 532 is disposed at or near the center of the eight camera arrangement, and is configured to reflect a portion of incoming light to each of the eight cameras 512a-h. In some embodiments the central reflective element 532 may comprise one component having at least eight reflective surfaces. In some other embodiments, the central reflective element 532 may be comprised of a plurality of individual components, each having at least one reflective surface. The multiple components of the central reflective element 532 may be coupled together, coupled to another structure to set their position relative to each other, or both.

In some embodiments, an optical axis (e.g., 530) of each camera of the eight cameras 512a-h can intersect any location on its associated central object side reflective surface. With this freedom of positioning and orienting the cameras, each of the cameras can be arranged such that its optical axis is pointed to a certain location on a corresponding associated reflective surface (that reflects light to the camera) that may yield a wider aperture than other intersection points on its associated reflective surface. Generally, the wider the aperture, the lower the f-number of a camera can be, provided the effective focal length of the camera remains substantially the same. Those skilled in the art may be aware that the lower the f-number the higher the diffraction limit of the optical system may be. The shape of the aperture may affect the shape of the Point Spread Function (PSF) and/or Line Spread Function (LSF) of the lens system and can be spatially different across the image plane surface. The aperture of the system can be affected by the reflective surface if not all the rays arriving from a point in the object space are reflected to the camera lens assembly, with respect to the rays that would have entered the camera if the center object side reflective surface associated with the camera were not present, where it is to be understood that in this case the camera's actual physical location would be at its vertical location with the same common entrance pupil with all the other cameras in the system.

As an example, the object side reflective surface associated with a camera can act as an aperture stop if it does not reflect rays that would normally enter the camera lens system that would normally enter if the reflective surface were not present. Another example is, the optical axis of the camera can intersect near an edge of the associated reflective surface and thereby reduce the visible area of the reflective surface associated with that camera. The rays outside of this area may not be reflected so that they enter the lens assembly of the camera as it would if the associated reflective surface were not present, whereby in this way the reflective surface can be considered a stop and as a result the effective aperture will be reduced relative to pointing at a location that would reflect more of the rays. Another advantage of being able to choose any location on the reflective surface as an intersect point of an associated camera is the image area on the image plane can be increased or maximized. For example, some embodiments may point at a location closer to an edge of the reflective surface and thereby reduce the image area as compared to another intersection point on the associated reflection surface which may produce a wider image area. Another advantage of choosing any intersection point on the reflective surface is an intersection location can be found that will produce a desired Point Spread Function (PSF) or Line Spread Function (LSF) across the image plane, for example a particular PSF or LSP shape at a subset of areas in the image area or across the image area. Another advantage of being able to change the intersection point of a cameras' optical axis on the reflective surface is the ability during calibration to find an alignment between all the cameras that will yield a desired orientation of the reflective surfaces in order to optimize all factors such as the image areas of the cameras and the shape of the PSF and LSF as seen across the image areas of the other cameras. Another advantage of being able to select the intersection point of the center reflective surface associated with a camera is added degrees of freedom when designing or developing the shape of the reflective surface in order to yield a desired orientation of the reflective surfaces in order to optimize all factors such as the image areas of the cameras and the shape of the PSF and LSF as seen across the image areas of the other cameras. It should be understood the reflective surfaces of the center object side reflector or refractive reflector element are part of the entire optical system so the shape of these surfaces can be other than planar and considered part of the optical system for each and every camera. For example the shape of each surface can be spherical, aspherical, or complex in other ways.

FIG. 1C illustrates a top view of an example of an embodiment of a four camera configuration 110. In some embodiments, a camera system has four (4) cameras 112a-d, each camera capturing a portion of a scene such that four images may be captured. The system includes a processor configured to generate an image of the scene by combining all or a portion of the four images. As illustrated in FIG. 1C, the four cameras 112a-d can be configured as a set of four (4) cameras, the four cameras 112a-d collectively forming a virtual central camera. A reflective element 138 is disposed at or near the center of the four camera arrangement, and is configured to reflect a portion of incoming light to each of the four cameras 112a-d. In some embodiments the reflective element 138 may comprise one component having at least four reflective surfaces. In some other embodiments, the reflective element 138 may comprise a plurality of individual components, each having at least one reflective surface. Because FIG. 1C illustrates a top view, the fields of view 120, 122, 124, 126 are illustrated as circles. The reflective surfaces 140, 142, 144, 146 can be a variety of optical elements, including but not limited to one or more mirrors or as illustrated here, a prism. The multiple components of the reflective element 138 may be coupled together, coupled to another structure to set their position relative to each other, or both.

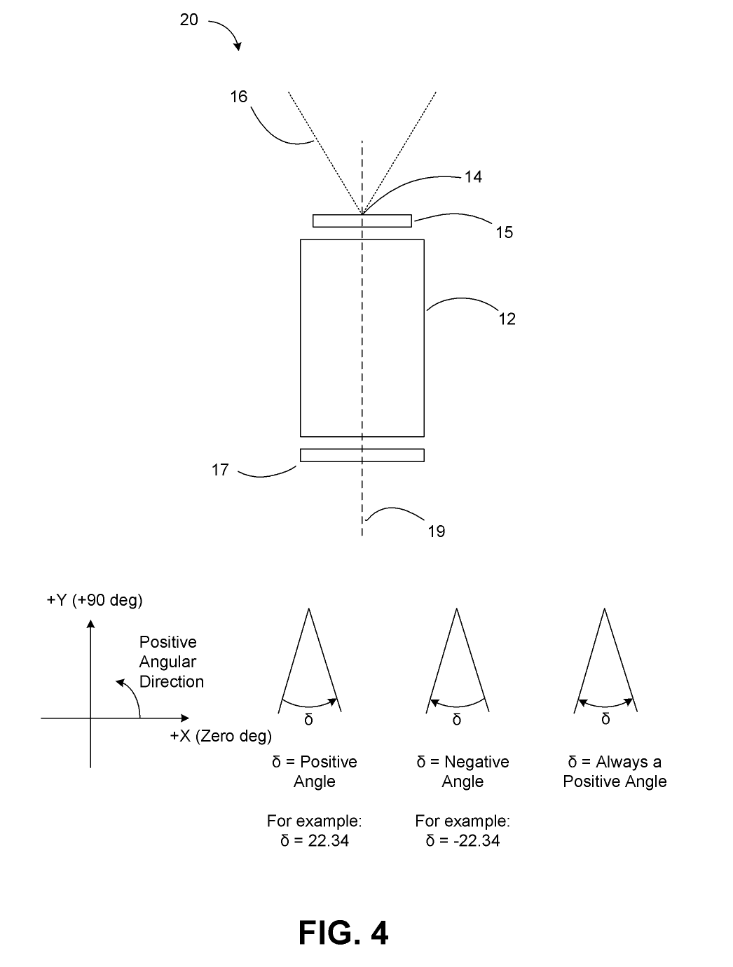

In some embodiments, the optical axes 128, 130, 132, 134 of each camera of the four cameras 112a-d can intersect any location on its associated central object side reflective surface 140, 142, 144, 146, so long as the cameras cooperate to form a single virtual camera. Further details of positioning the cameras and aligning their respective optical axes is described in reference to FIGS. 4A and 4B. With this freedom of positioning and orienting the cameras, each of the cameras can be arranged such that its optical axis is pointed to a certain region on a corresponding associated reflective surface 140, 142, 144, 146 (that reflects light to the camera) that may yield a wider aperture than other intersection points on its associated reflective surface 140, 142, 144, 146. Generally, the wider the aperture, the lower the f-number of a camera can be, provided the effective focal length of the camera remains substantially the same. Those skilled in the art may be aware that the lower the f-number the higher the diffraction limit of the optical system may be. The shape of the aperture may affect the shape of the Point Spread Function (PSF) and/or Line Spread Function (LSF) of the lens system and can be spatially different across the image plane surface.

Reflective surfaces 140, 142, 144, 146 can reflect light along the optical axes 128, 130, 132, 134 such that each of the corresponding cameras 112a-d can capture a partial image comprising a portion of the target image according to each camera's field of view 120, 122, 124, 126. The fields of view 120, 122, 124, 126 may share overlapping regions 148, 150, 152, 154. The captured portions of the target image for each of cameras 112a-d may share the same or similar content (e.g., reflected light) with respect to the overlapping regions 148, 150, 152, 154. Because the overlapping regions 148, 150, 152, 154 share the same or similar content, this content can be used by an image stitching module to output a target image. Overlaying image portion 136 includes portions of the reflected portions of the target image. Using a stitching technique, the stitching module can output a target image to an image processor. For example, overlapping regions 148, 150, 152, 154 of the fields of view 120, 122, 124, 126 may be used by an image stitching module to perform a stitching technique on the partial images captured by cameras 112a-d and output a stitched and cropped target image to an image processor.

In order to output a single target image, the image stitching module may configure the image processor to combine the multiple partial images to produce a high-resolution target image. Target image generation may occur through known image stitching techniques. Examples of image stitching can be found in U.S. patent application Ser. No. 11/623,050 which is hereby incorporated by reference.

For example, the image stitching module may include instructions to compare the areas of overlap along the edges of the partial images for matching features in order to determine rotation and alignment of the partial images relative to one another. Due to rotation of partial images and/or the shape of the field of view of each sensor, the combined image may form an irregular shape. Therefore, after aligning and combining the partial images, the image stitching module may call subroutines which configure the image processor to crop the combined image to a desired shape and aspect ratio, for example a 4:3 rectangle or 1:1 square. The cropped image may be sent to the device processor for display on the display or for saving in the storage.

### C. Overview of Parallax Free Camera Positioning

The imaging system of FIG. 2A includes a plurality of cameras. Central camera 112 is located in a position having a first field of view a directed towards a first direction. The first field of view a, as shown in FIG. 2A, faces a first direction which can be any direction the central camera 112 is facing. The central camera 112 has an optical axis 113 that extends through the first field of view a. The image being captured by central camera 112 in the first field of view a is around a projected optical axis 113 of the central camera 112, where the projected optical axis 113 of central camera 112 is in the first direction.

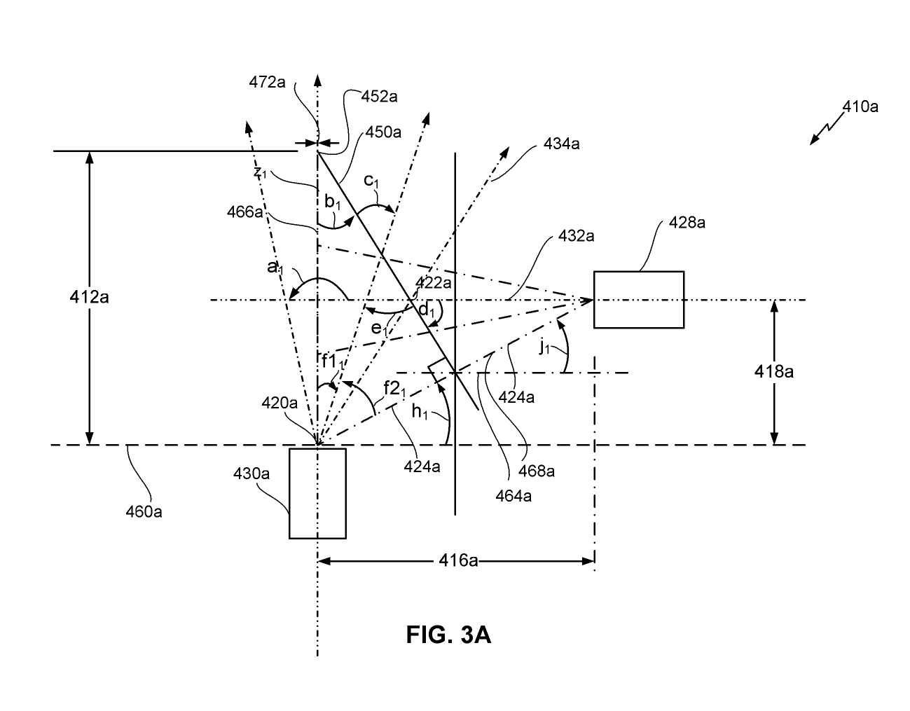

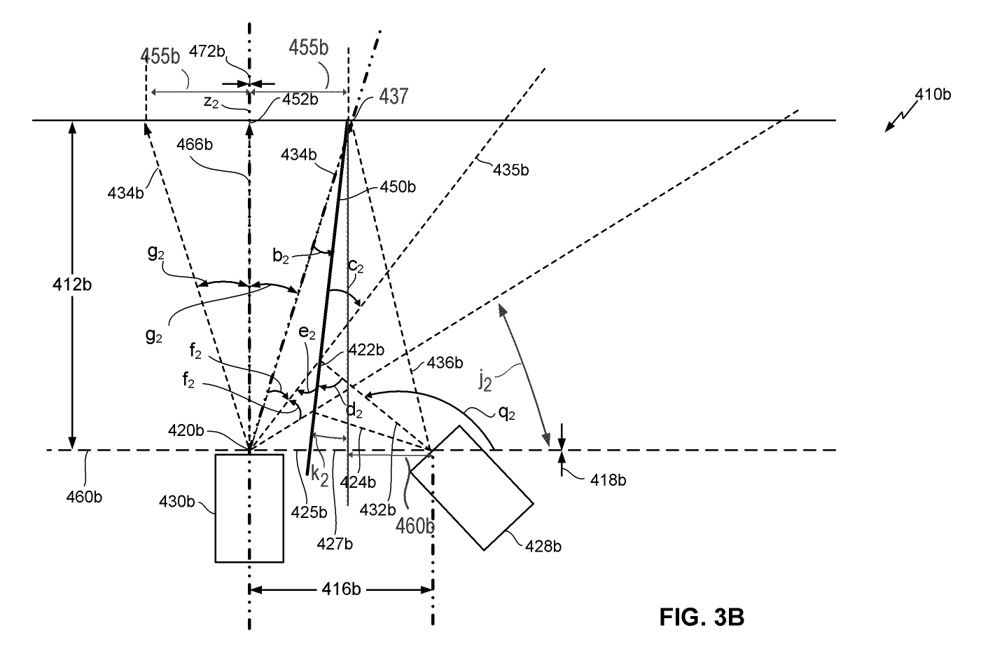

FIG. 2B illustrates a side cross-section view of the central camera 112, camera 116a and its associated mirror component 126a. The arrangements of each of the side cameras 116a-d are positioned around the illustrated optical axis 113 of camera 112. Each of the plurality of side cameras 116a-d may be referred to as a “concentric ring” of cameras, in reference to each of the pluralities of side cameras 116a-d forming a ring which is concentric to the illustrated line 113 which is the optical axis of the actual camera 112. For clarity, only one camera from each of the rings 116a-d and the central camera 112 are shown in FIGS. 2A and 2B. Side camera 116a is part of a second concentric ring of 4 cameras, each of the 4 cameras being positioned 90 degrees from its neighboring camera to form a 360 degree concentric ring of cameras. Side cameras 114a-d are not shown in FIG. 2A. Similarly cameras 114a-d are part of first concentric rings of cameras positioned similarly to the cameras of the second concentric ring of cameras, which will be further described when FIG. 3 is explained. The term “ring” is used to indicate a general arrangement of the cameras around, for example, line 113, the term ring does not limit the arrangement to be circular-shaped. The term “concentric” refers to two or more rings that share the same center or axis.

As shown in FIG. 2A, the radius 1542b of each second concentric ring about the optical axis 113, is the distance from the optical axis line 113 to the center most point of the entrance pupil of camera 116a. Similarly as shown in FIG. 2B, the radius 1541a of the first concentric ring about the optical axis 113 is the distance from the optical axis line 113 and the center most point of the entrance pupil for camera 114a. In some embodiments the radius distances 1542d and 1541a may be equal for all cameras 116a-d and cameras 114a-d, respectfully. It is not necessary that the radius distance 1542d is equal for all cameras in the second concentric rings. Similarly, it is not necessary the radius 1541a is equal for all cameras in the first concentric ring. The embodiment shown in FIG. 2A has the same radius 1542b for all cameras 116a-d and similarly the embodiment shown in FIG. 2B has the same radius 1541a for all cameras 114a-d.

The first concentric ring of cameras 114a-d are arranged and configured to capture images in a third field of view c in a direction along an optical axis 115. The second concentric ring of cameras 116a-d are arranged and configured to capture images in a second field of view b in a direction along an optical axis 117.

In another embodiment, the side cameras 114a-d, 116a-d, are each respectively part of a first, and second set of array cameras, where each of the first, and second set of array cameras collectively have a field of view that includes at least a portion of the target scene. Each array camera includes an image sensor. The image sensor may be perpendicular and centered about the optical axis 186a-d of each respective camera 116a-d as shown schematically in FIG. 2A for the second concentric ring. Similarly, the image sensor may be perpendicular and centered about to the optical axis 184a-d of each respective camera 114a-d as shown schematically in FIG. 2B for the first concentric ring.

As will be shown herein it may be possible to replace camera 112 shown in FIG. 2A with a field of view “a” with the first concentric ring of cameras 114a-d as shown in FIG. 2B if the field of view “c” is approximately greater or equal to one-half the field of view “a”. In such a case cameras 116a-d in the second concentric ring and cameras 114a-d in the first concentric ring can be configured and arranged such that images captured by all cameras 114a-d and 116a-d may collectively represent a wide field of view image as seen from a common perspective vantage point located substantially or effectively at the centermost point of the vertical entrance pupil of all the cameras 114a-d and 116a-c of the imaging system, where the center most point of the virtual entrance pupil of all the cameras 114a-d and 116a-d have been configured and arranged such that the centermost point of all virtual entrance pupils are substantially or effectively at one common point in space.

The imaging concentric ring systems shown in FIGS. 2A and 2B include a light redirecting reflective mirror surfaces 134a-d for the first concentric ring shown in FIG. 2B and a light redirecting reflective mirror surfaces 136a-d for the second concentric ring shown in FIG. 2A.

In each of the above light redirecting reflective mirror components 134a-d, 136a-d, the light redirecting reflective mirror components 134a-d, 136a-d, include a plurality of reflectors.

As will now be described, the wide field of view camera configuration 100a comprises various angles and distances that enable the wide field of view camera configuration 100a to be parallax free or effectively parallax free and to have a single virtual field of view from a common perspective. Because the wide field of view camera configuration 100a has a single virtual field of view, the configuration 100a is parallax free or effectively parallax free.

In some embodiments, such as that shown in FIGS. 1A-2B, the single virtual field of view comprises a plurality of fields of view that collectively form a wide field of view scene as if the virtual field of view reference point of each of cameras 114a-d, and 116a-d have a single virtual point of origin 145, which is the effective center most point of the entrance pupil of the camera system 100a located at point 145. The first concentric ring of cameras 114a-d captures a portion of a scene according to angle c, its virtual field of view from the single point of origin 145, in a direction along the optical axis 115. Second concentric ring camera 116a-d captures a portion of a scene according to angle b, its virtual field of view from the single point of origin 145. Because the first concentric ring of cameras 114a-d, and the second concentric ring of cameras 116a-d collective virtual fields of views will capture a wide field of view scene that includes at least the various angles b and c of the virtual fields of views. In order to capture a wide field of view, all of the cameras 114a-d, 116a-d individually need to have sufficiently wide enough fields of view to assure all the actual and or virtual fields of view fully overlap with the actual and or virtual neighboring fields of view to be sure all image content in the wide field of view may be captured.

The single virtual field of view appears as if each of the cameras is capturing a scene from a single point of origin 145 despite the actual physical locations of the cameras being located at various points away from the single point of origin 145. As shown in FIG. 2B the virtual field of view of the first camera 114a would be as if the first camera 114a were capturing a scene of field of view c from the center most point of the virtual entrance pupil located at 145. And similarly, the virtual field of view of the second camera 116a as shown in FIG. 2A would be as if the second camera 116a were capturing a scene of field of view b from the center most point of the virtual entrance pupil located at 145 Accordingly, the first camera 114a, second camera 116a have a single virtual field of view reference point at the center most point of the virtual entrance pupil located at 145.

In other embodiments, various fields of view may be used for the cameras. For example, the first camera 114a may have a narrow field of view, the second camera 116a may have a wide field of view, the third camera 114b may have a narrower field of view and so on. As such, the fields of view of each of the cameras need not be the same to capture a parallax free or effectively parallax free image. However, as described below in an example of one embodiment and with reference to the figures and tables, the cameras have actual fields of view of approximately 60 degrees so that it may be possible to essentially overlap the neighboring fields of view of each camera in areas where the associated mirrors and component are not blocking or interfering with the light traveling from points in space towards associated mirrors and then on to each respective cameras actual entrance pupil. In the embodiment described below, the fields of view essentially overlap. However, overlapping fields of view are not necessary for the imaging system to capture a parallax free or effectively parallax free image.

The above described embodiment of a parallax free or effectively parallax free imaging system and virtual field of view is made possible by various inputs and outputs as listed in the following tables of angles, distances and equations.

One concept of taking multiple images that are free of parallax artifacts or effectively free of parallax artifacts is to capture images of a scene in the object space by pivoting the optical axis of a camera where the center most point of the camera's entrance pupil remains in the same location each time a image is captured. Those skilled in the art of capturing panoramic pictures with none or effectively minimal parallax artifacts may be aware of such a method. To carry out this process one may align the optical axis of camera 112, as shown in FIG. 2A, along the optical axis 115, as shown in FIG. 2B, and place the center most point of camera 112 entrance pupil to contain point 145, where in this position the optical axis of camera 112 should be at an angle h1 from the camera system optical axis 113 where optical axes 113 and 115 effectively intersect each other at on or near the point 145. At this position an image can be captured. The next step one may rotate clockwise the optical axis of camera 112 to the optical axis 117 as shown in FIG. 2A, where in this position the optical axis of camera 112 should be at an angle (2*h1+h2) from the camera system optical axis 113 where optical axes 113, 115 and 117 effectively intersect each other at on or near the point 145. While in both angular directions 115 and 117 the point 145 is kept in the center most point of camera 112 entrance pupil and keeping the optical axis of camera 112 in the plane of the page shown respectfully in FIGS. 2A and 2B and then capture a second image. Let's further assume the field of view of camera 112 is actually greater than the larger of angles 2*f₂, 2*h₁ and 2*h₂. Both these images should show similar object space image content of the scene where the fields of view of the two images overlap. When the images are captured in this way it should be possible to merge these two images together to form an image that has no parallax artifacts or effectively no parallax artifacts. Those skilled in the art of merging two or more images together may understand what parallax artifacts may look like and appreciate the objective to capture images that are free of parallax for effectively free of parallax artifacts.

It may not be desirable to capture parallax free or effectively parallax free images by pivoting the optical axis of a camera about its entrance pupil location. It may be preferable to use two cameras fixed in position with respect to each other. In this situation it may not be possible to make two cameras with their entrance pupils occupying the same physical location. As an alternative one may use a light redirecting reflective mirror surface to create a virtual camera that has its entrance pupil center point containing or effectively containing the entrance pupil center point of another camera such as 112, such as that shown in FIG. 2A. This is done by appropriately positioning a light redirecting reflective mirror surface, such as surface 136a, and the second camera, such as 116a. FIG. 2A provides a drawing of such a system where a light redirecting reflective mirror surface 136a is used to create a virtual camera of camera of 116a, where the center of the virtual camera entrance pupil contains point 145. The idea is to position the light redirecting reflective mirror surface 136a and place camera 116a entrance pupil and optical axis in such a way camera 116a will observe off the light redirecting reflective mirror 136a reflective surface the same scene its virtual camera would observe if the light redirecting reflective mirror surface was not present. It is important to point out the camera 116a may observe only a portion of the scene the virtual camera would observe depending on the size and shape of the light redirecting reflective mirror surface. If the light redirecting reflective mirror surface 136a only occupies part of the field of view of camera 116a then camera 116a would see only part of the scene its virtual camera would see.

Once one selects values for the length 1522ₐ and the angles f₂, h₂ and k₂, as shown in FIG. 2A, one can use the equations of Table 1 to calculate the location of camera 116a entrance pupil center point and the angle of its optical axis with respect to line 111. The entrance pupil center point of camera 116a is located a distance 1542ₐ from the multi-camera systems optical axis 113 and length 1562ₐ from the line 111, which is perpendicular to line 113. FIG. 4, described below, provides the legend showing angular rotation direction depending on the sign of the angle and the direction for lengths from the intersection point of lines 111 and 113 depending on the sign of the length.

TABLE 1
Inputs

| | | |
|---|---|---|
| (Distance 1522ₐ) | 2 | mm |
| f₂ | 21 | deg |
| h₂ | 15 | deg |
| k₂ | 27 | deg |

Outputs

| | | | |
|---|---|---|---|
| u1 | 27 | = k₂ | deg |
| u2 | −63 | = −90 + u1 | deg |
| j₂ | 39 | = 90 − (f₂ + 2 * h₂) | deg |
| (Distance 158ₐ) | 2.142289987 | = (Distance 1522ₐ)/cos(f₂) | mm |
| (Distance 150ₐ) | 0.76772807 | = (Distance 158ₐ) * sin(f₂) | mm |
| (Distance 160ₐ) | 1.592031719 | = (Distance 158ₐ) * | mm |
| | | cos(2 * h₂ − u1 + j₂) | |
| (Distance 1562ₐ) | 1.445534551 | = 2 * (Distance 160ₐ) * | mm |
| | | sin(u1) | |
| (Distance 1542ₐ) | 2.837021296 | = 2 * (Distance 160ₐ) * | mm |
| | | cos(u1) | |
| m₂ | 63 | = 90 − (h₂ + j₂ − u1) | deg |
| n₂ | 63 | = m₂ | deg |
| p₂ | 63 | = n₂ | deg |
| q₂ | 180 | = 180 − | deg |
| | | (180 − (h₂ + j₂ + p₂ + m₂)) | |

The distances, angles and equations in Table 1 and 2 will now be described with reference to FIGS. 2A and 2B. With reference to FIGS. 2A and 2B, line 111 can be thought of as a plane containing the virtual entrance pupil 145 and is perpendicular to the multi-camera system optical axis 113, where the optical axis 113 is contained in the plane of the page. The center most point of the virtual entrance pupil 145 is located ideally at the intersection of the plane 111 and the optical axis 113, where the plane 111 is perpendicular to the page displaying the figure. In actual fabrication variations in components and positioning may result in the center point of the entrance pupil 145 not being at the intersection of the optical axis 113 and the plane 111; and, likewise, it may be the actual location and alignment of the virtual entrance pupil center most point of camera 114a, as shown in FIG. 2B may not exactly coincide with a the common virtual entrance pupil 145, where in these cases we can use the concepts of “effective” or equivalently worded as “effectively” to mean that if it is possible to show tolerances requirements can be determined such that the intended requirements and or purposes for the system, systems or item are being fulfilled, then both the ideal case and within aforementioned tolerances the system, systems and or item may be considered equivalent as to meeting the intended requirements and or purposes. Hence, within tolerances the virtual entrance pupil 145 effectively coincides with the virtual entrance pupil of camera 114a and the center most point of the virtual entrance pupil of all of the cameras used in the multi-camera system, such as cameras 114a-d and 116a-d being described in the embodiment shown and or described in FIGS. 1A-11 herein. Further, optical axes of all the cameras, such as 114a-d and 116a-d effectively intersect with the plane 111, optical axis 113 and the multi-camera system common virtual entrance pupil center most point 145.

The meaning of the current camera will change for each of the Tables 1 and 2. For Tables 2, we will refer to the camera having the half angle field of view of h1 as being the current camera. The current camera as it pertains to Table 2 applies to the set of cameras 114a-d

The current camera and all of the cameras used for an embodiment may each be a camera system containing multiple cameras or may be another type of camera that may be different than a traditional single barrel lens camera. In some embodiments, each camera system used may be made up of an array of cameras or a folded optics array of cameras.

TABLE 2
Inputs

| | | |
|---|---|---|
| (Distance 1521ₐ) | 4 | mm |
| f₁ | 0 | deg |
| h₁ | 15 | deg |
| k₁ | 37.5 | deg |

Outputs

| | | | |
|---|---|---|---|
| u1 | 37.5 | = k₁ | deg |
| u2 | −52.5 | = −90 + u1 | deg |
| j₁ | 60 | = 90 − (f₁ + 2 * h₁) | deg |
| (Distance 158ₐ) | 4 | = (Distance 1521ₐ)/cos(f₁) | mm |
| (Distance 150ₐ) | 0 | = (Distance 158ₐ) * sin(f₁) | mm |
| (Distance 160ₐ) | 2.435045716 | = (Distance 158ₐ) * | mm |
| | | cos(2 * h₁ − u1 + j₁) | |
| (Distance 1561ₐ) | 2.96472382 | = 2 * (Distance 160ₐ) * | mm |
| | | sin(u1) | |
| (Distance 1541ₐ) | 3.863703305 | = 2 * (Distance 160ₐ) * | mm |
| | | cos(u1) | |
| m₁ | 52.5 | = 90 − (h₁ + j₁ − u1) | deg |
| n₁ | 52.5 | = m₁ | deg |
| p₁ | 52.5 | = n₁ | deg |
| q₁ | 180 | = 180 − | deg |
| | | (180 − (h₁ + j₁ + p₁ + m₁)) | |

Below we will refer to terms first camera because it is from the first ring of cameras. Similarly we will refer to the second camera because it is from the second ring of cameras. In FIG. 2A, the angles and distances of Table 1 are illustrated. The entrance pupil of the first camera 116a is offset from the virtual entrance pupil 145 according to Distance 1542ₐ and Distance 1562ₐ. Distance length 1542ₐ represents the coordinate position from the optical axis 113 and the entrance pupil center point of the second camera 116a, where the distance 1542a is measured perpendicular to the optical axis 113. Here, the current camera is second camera 116a.

Distance length 1562ₐ represents the coordinate position from the plane 111 and a plane containing the entrance pupil center point of the first camera 116a and is parallel to plane 111. Here, the current camera is second camera 116a.

Still referring to FIG. 2A, point 137 shown in FIG. 2A for system 200a is located on the plane of the page showing FIG. 2A and is distance 150a from the optical axis 113 and distance 1522a from the line formed by the intersection of plane 111 and the plane of the page for FIG. 2A. For ease of explaining sometimes we will refer to line 111, which is to be understood as the line formed by the intersection of plane 111 and the plane of the page showing FIG. 2A.

Planar light redirecting reflective mirror surface 136a is shown with the line formed by the intersection of the planar surface 136a and the plane of the page showing FIG. 2A. For the purpose of explaining FIGS. 2A and 2B we will assume planar surfaces 134a and 136a are perpendicular to the plane of the page. However, it is important to point out that the planar surface 134a and 136a do not need to be perpendicular to the plane of the page.

When we refer to line 136a it is to be understood we are referring to the line formed by the intersection of planar surface 136a and the plane of the page. Also, when we refer to line 134a it is to be understood we are referring to the line formed by the intersection of planar surface 134a and the plane of the page.

Table 1 provides the angle k₂ which is the clockwise rotation angle from the line 136a to a line parallel to the optical axis 113 and also contains point 137, where point 137 is also contained in the plane of the page and line 136a. The field of view edges of camera 112 is shown by the two intersecting lines labeled 170a and 170b, where these two lines intersect at the center most point 145 of the entrance pupil of camera 112. The half angle field of view of camera 112 is f₂ between the multi-camera optical axis 113 and the field of view edge 170a and 170b.

As shown in FIG. 2A, camera 112 has its optical axis coinciding with line 113. The half angle field of view of camera 116a is h₂ with respect to camera 116a optical axis 117. The optical axis of camera 116a is shown being redirected off of light redirecting reflective mirror surface 136a. Assume the light redirecting reflective mirror surface 136a is perfectly flat and is a plane surface perpendicular to the plane of the page FIG. 2A. Further assume the light redirecting reflective mirror planar surface 136a fully covers the field of view of camera 116a. As shown in FIG. 2A, the optical axis 117 intersects at a point on the planar light redirecting reflective mirror surface 136a. Counter clockwise angle p2 is shown going from light redirecting reflective mirror surface 136a to the optical axis 117 of camera 116a. Based on the properties of light reflection off a mirror or equivalent light reflecting mirror surface, and the assumption the lines shown in FIG. 2A are contained in the plane of page of FIG. 2A, we find counter clockwise angles m2 and n2 are equal to p₂. A light ray may travel along the optical axis 117 towards camera 116a within the plane of the page showing FIG. 2A and reflect off the light redirecting reflective mirror equivalent surface 136a towards the center point of the entrance pupil of camera 116a, where the angles n₂ and p₂ must be equal based on the properties of light reflection off mirror equivalent surfaces. The optical axis 117 of camera 116a is shown extending pass the light reflecting surface 136a towards the virtual entrance pupil center point 145, where the virtual entrance pupil center most point is effectively located. Counter clockwise rotation angle m₂ can be shown to be equal to n₂ based on trigonometry.

For all surfaces 136a-d and 134-d shown we will assume, for the purposed of explaining the examples described herein that these surfaces are planar and perpendicular to the plane of the page in the figures as well as the descriptions.

From this we it can be shown that an extended line containing the planar light redirecting reflective mirror surface 136a will intersect perpendicularly the line going from the entrance pupil center point of camera 112 to the entrance pupil center point of camera 116a. Hence the two line lengths 160a can be shown to be equally distant.

It is possible the planar light redirecting reflective mirror surface 136a covers only part of the field of view of camera 116a. In this case not all the rays that travel from the object space towards the virtual camera entrance pupil that contains at its center most point 145, as shown in FIG. 2A, will reflect off the planar portion of a the light redirecting reflective mirror surface 136a that partially covers the field of view of camera 116a. From this perspective it is important to keep in mind camera 116a has a field of view defined by half angel field of view h₂, the optical axis 117 and the location of its entrance pupil as described by lengths 1542a and 1562a and the legend shown in FIG. 4. Within this field of view a surface such as the light reflecting planar portion of the light redirecting reflective mirror surface 136a may be partially in its field of view. The light rays traveling from the object space toward the entrance pupil of the virtual camera of camera 116a and reflect off the planar portion of light redirecting reflective mirror surface 136a will travel onto the entrance pupil of camera 116a provided the planar portion of light redirecting reflective mirror surface 136a and cameras 112 and 116a are positioned as shown in FIG. 2A, and in accordance with the legend shown on FIG. 4, the equations of Table 1 and in accordance with the input values 1522a, f₂, h₂ and k₂.

FIG. 2B illustrates a side view of an example of an embodiment of a portion of the wide field of view camera configuration 300a including a central camera 112, a first camera 114a. Notice it does not include a camera 112. This is because camera system 300a can be used in place of camera 112 shown in FIG. 2A. The parameters, angles and values shown in Table 2 will place the camera 114a entrance pupil, optical axis 115 and the respective mirror 134a positions such that camera 114a will cover a portion of camera 112 field of view. If we use Table 1 to calculate the positions of cameras 114b-d in the same way as we did for 114a, then it should be possible capture images that collectively will include the field of view a of camera 112, provided the half field of view h1 is greater than or equal to f2 and the actual field of view of camera 114a-d are sufficiently wide enough so that when the collective images are stitched together the scene content of 112 will be within the captured image of the scene content of the stitched together images of the camera system 300a. In this example camera system 300a will be used to replace camera 112, provided camera system 300a captures the same scene content within the circular Field of View a of camera 112 as shown in FIG. 2A. In a more general view camera 112 may be not necessary if the images captured by cameras 114a-d and cameras 116a-d collectively contain the same scene content after the images are stitched together as that captured by camera 112 and cameras 116a-d after the images are stitched together. In this embodiment, the second camera 114a is the current camera as shown in FIG. 2B.

What the intended meaning is for phrase or similar phases such as “scene content” and the like mean is the scene content relates to the light traveling in a path from points in the object space towards a the camera system. The scene content that is carried by light is contained in the light just before entering the camera system. The camera system may affect the fidelity of the image captured; i.e. the fidelity of the camera system may introduce artifacts such as the camera system may alter the light or add artifacts and or add noise to the light before or during the process of capturing an image from the light by a the image detector. Other factors related to the camera system and aspects outside of the camera system may also affect the fidelity of the image capture with respect to the scene content contained in the light just before entering the camera system.

The above distances, angles and equations have a similar relationship as described above with respect to FIG. 2A. Some of the inputs of Table 2 differ from the inputs of Tables 1. In FIG. 2B and Table 2, some of the distances have identifications numbers and a subscript “a”, such as 1521a, 1541a, and or 1561a″ and some of the angles have a subscript “1.” These subscripted distances and angles of Table 2 have a similar relationship to the subscripted distances and angles of FIG. 2A and Table 1. For example, FIG. 2A and Table 1 may show similar identification numbers with subscript “a”, such as 1522a, 1542a, and or 1562a and some of the angles may have subscript “2” instead of “1”.

An explanation of one way to design a multi-camera system will now be explained. One approach is to develop a multi-camera system using the model shown in FIG. 2A, the legend shown in FIG. 4 and the equations shown in Table 1. One of the first decisions is to determine if the central camera 112 will be used. If the central camera 112 is not to be used then half angle field of view f₂ should be set to zero. In the example presented Tables 1 and 2 and the FIGS. 2A and 2B, the half field of view angle f2 shown in Table 1 is not zero, so a real actual central camera 112 is part of the schematic design shown in FIG. 2A and described in Table 1. Next the half angle field of view h₂ may be selected based on other considerations those designing such a system may have in mind. The length 1522a, as shown in FIG. 2A, will scale the size of the multi-camera system. One objective while developing a design is to assure the sizes of the cameras that may or will be used will fit in the final structure of the design. The length 1522a can be changed during the design phase to find a suitable length accommodating the cameras and other components that may be used for the multi-camera system. There may be other considerations to take into account when selecting a suitable value for 1522a. The angle k₂ of the light redirecting reflective mirror planar surface can be changed with the objective of finding a location for the entrance pupil center most point of camera 116a. The location of the entrance pupil center most point of camera 116a is provided by the coordinate positions 1542a and 1562a and the legend shown on FIG. 4. The optical axis of 116a, in this example, is contained in the plane of the page, contains the entrance pupil center most point of camera 116a and is rotated by an angle q₂ counter clockwise about the center most point of the camera's 116a entrance pupil with respect to a line parallel with line 111, where this parallel reference line also contains the center most point of camera's entrance pupil.

One may want the widest multi-camera image one may be able to obtain by merging together all the images from each camera in the system; i.e. cameras 112 and 116a-d. In such a case it may be desirable to keep each camera and or other components out of the fields of view of all the cameras, but it is not necessary to keep each camera or other components out of the fields of view of one or more cameras because factors such as these depend on the decisions made by those designing or developing the camera system. One may need to try different inputs for 1522a, f₂, h₂, and k₂ until the desired combined image field of view is achieved.

Once a multi-camera system has been specified by inputs 1522a, f₂, h₂, and k₂ according to Table 1 and FIG. 2A, we now have positions and arrangements for the cameras 112, 116a-d and light redirecting reflective mirrors 136a-d. Table 1 shows an example of input values for 1522a, f₂, h₂, and k₂ and the resulting calculated values for camera system example being described. Accordingly one can use the values in Table 1 and the drawing shown in FIG. 2A as a schematic to develop such a camera system.

Suppose we would like to replace camera 112 with a multiple camera arrangement. One way to do this is to use the model shown in FIG. 2A and set the half angle value f2 to zero. Such a system is shown in FIG. 2B, where camera 112 is not present. The center most point 145 of the virtual entrance pupil for camera 114a is shown in FIG. 2B. Table 2 shows example inputs values for length 1521a and angles f1, h1, and k1 and the resulting calculated values using the equations of Table 1. The multi-camera system of cameras 114a-d in accordance with the camera system represented by FIG. 2B and Table 2 should be able to observe the same scene content within the field of view a of camera 112. Accordingly one should then be able to replace camera 112 in FIG. 2A and described in Table 1 with the multi-camera system schematic example described by FIG. 2B and Table 2. If camera system described by FIG. 2B and Table 2 can physically be combined with the multi-camera system described by FIG. 2A and Table 1 without camera 112 being present, and where the point 145 is the center most point of virtual entrance pupil of all the cameras 114a-d and 116a-d then we should have a multi-camera system that does not include a center camera 112 and should be able to observe the same scene content as the multi-camera system shown in FIG. 2A and described in Table 1 using a the center camera 112 and cameras 116a-d. In this way we can continue to stack a multi-camera system on top of another multi-camera system while having center most point of all the cameras virtual entrance pupil effectively located at point 145 as shown in FIG. 2A.

In the example shown in FIGS. 2A and 2B and Tables 1 and 2 it may be necessary to rotate the camera system shown in FIG. 2B by and angle such as 22.5 degrees about the camera system optical axis 113 in order for cameras 114a-d and 116a-d to fit with one and other. FIG. 1A provides an example of such an arrangement.

One can think of the camera system containing cameras 114a-d as the first concentric ring about the multi-camera system's optical axis 113 and described by FIGS. 2A and 2B and Tables 1 and 2. Likewise one can think of the camera system containing cameras 116a-d as the second concentric ring. One can continue to add concentric rings of cameras where for each ring there is essentially a table like that shown in Table 1 and additionally the virtual entrance pupil center most point of all the cameras in the multi-camera system is effectively located at point 145 as shown in FIG. 2A.

For example, once the design for the first and second concentric rings are complete and aligned so they fit together, one can consider adding a third concentric ring using the same approach described above for rings 1 and 2. The process can continue in this way as long as the cameras can all fit with one another and meet the design criteria of the multi-camera system being design and or developed.

The shape of each concentric ring can be different than the other concentric rings. Given such flexibility one could design a camera system using the principles above and create a system of cameras that follow a contour of a surface other than a flat surface, such as polygonal surfaces such as a parabolic shape or elliptical shape or many other possible shapes. In such case the individual cameras can each have different fields of view than the others or in some cases they can have the same field of view. There are many ways to use the methods describe above to capture an array of images. It is not necessary for the images of the cameras to overlap. The images can be discontinuous and still have the properties of being parallax free or effectively parallax free.

There may be more or less camera rings than the first ring, the second ring, the third ring and so one. By using more or less camera rings you may be able to devise, design or conceive of a wide field of view camera, a hemisphere wide field of view camera or a ultra wide field of view camera greater than a hemisphere or as much of a spherical camera as maybe be desired or required. An actual design depends on the choices made while developing a multi-camera system. As previously stated it is not necessary for any of the cameras to have the same field of view as any of the other cameras. All of the light redirecting reflective mirror surfaces do not have to have the same shape, size or orientation with respect to its associated camera or cameras viewing that light redirecting reflective mirror surface. It should be possible to arrange a camera system using the principles, descriptions and methods described herein and the light redirecting reflective mirrors so that more than one camera can share the same light redirecting mirror system. It should be possible to use a not planar light redirecting mirror surface to capture wide field of view images using the descriptions and methods described herein. It is also not necessary for all the cameras to fully overlap the fields of view of the neighboring images in order to have a multi-camera system described as being capable of capturing parallax free or effectively parallax free images.

One other aspect or feature of the model shown in FIG. 2A is the optical axis 117 intersecting the light redirecting reflective mirror surface 136a, is it can be shown that a multi-camera system such as that shown in FIG. 2A will still be parallax free or effectively parallax free if the intersection point of the optical axis 117 is moved to any location on the planar light redirecting reflective mirror surface 136a. The intersection point is the point where the optical axis 117 of camera 116a intersects the optical axis of its virtual camera and the intersection point is located on the planar light redirecting reflective mirror surface 136a. One can think of the virtual camera of camera 116a as a camera whose entrance pupil center most point is point 145 and whose optical axis intersects the light redirecting reflective mirror surface 136a at the same location the optical axis 117 of camera 116a interests mirror surface 136a. In this way the virtual camera of 116a will move as the optical axis 117 of camera 116a intersects different locations on the mirror surface 136a. Also, the light redirecting reflective mirror surface 136a can be any angle with respect to the plane of the page of FIG. 2A. In this way camera 116a, which is the real camera in this case, is associated with its virtual camera have the same optical axis as that of camera 116a between the mirror surface 136a and the scene in the object space.

In a multi-camera parallax free or effectively parallax free camera system the fields of view of each of the cameras used do not have to be equal.

It may be possible to design a parallax free or effectively parallax free multi-camera system where the light redirecting reflective mirror surfaces represented by light redirecting reflective mirror surface 136a in FIG. 2A in such a way that surface 136a is not planar but could reflect or refract light that is part of the design of an overall camera system. The mirror surface may be accomplished in many ways. Those skilled in the art may know of some such as using total internal reflection properties of a material that has a planar or other contour shapes. One may use a material that refracts light where the light may reflect off a reflective material attached to the surface of a refractive material and not have to depend on properties such as total internal reflection to achieve a light redirecting reflect mirror like surface.

FIG. 3A illustrates a schematic 410 of one camera 428 of one example of an embodiment of a multiple camera configuration. With respect to FIG. 3A, angles will be indicated using small alpha characters (e.g., j), distances will be indicated using distance designations (e.g., Distance 412) and points, axes, and other designations will be indicated using item numbers (e.g., 420). As shown below in Tables 1 and 2, a number of inputs Distance 412, z, f1-2, j are used to determine a number of outputs j, b, h, Distance 412, Distance 472, Distance 424a-b, Distance 418, Distance 416, e, c, d, a for the configuration of schematic 410. The configuration of FIG. 3A results in a camera with sixty (60) degrees dual field of view, provided that camera 428 does not block the field of view.

The input parameters will now be described. Distance 412 represents the distance from the virtual entrance pupil 420 of the camera 428 to the furthest terminal end of the reflective surface 450, which is at the point 452 of the prism. Distance 412 can be approximately 4.5 mm or less. In FIG. 3A, distance 412 is 4 mm.

Angle z represents the collective field of view of the camera configuration between the optical axis 466 of the virtual field of view of the schematic 410 and a first edge 466 of the virtual field of view of the camera 428. In this embodiment, angle z is zero (0) because the optical axis 466 of the virtual field of view is adjacent to the first edge 466 of the virtual field of view of the camera 428. The virtual field of view of the camera 428 is directed towards the virtual optical axis 434 and includes the area covered by the angles f1-2. The virtual optical axis 466a of the entire multiple camera configuration (other cameras not shown) is a virtual optical axis of the combined array of multiple cameras. The virtual optical axis 466a is defined by the cooperation of at least a plurality of the cameras. The virtual optical axis 466a passes through the optical component 450a. A point of intersection 420a of the virtual optical axis 466a is defined by the intersection of optical axis 434a and virtual optical axis 466a.

The optical component 450a has at least four light redirecting surfaces (only one surface of the optical component 450a is shown for clarity and the optical component 450a represents the other light redirecting surfaces not shown in FIG. 3A). At least four cameras (only camera 428a is shown for clarity and camera 428a represents the other cameras in the system illustrated in FIG. 3A) are included in the imaging system. Each of the at least four cameras 428a are each configured to capture one of a plurality of partial images of a target scene. Each of the at least four cameras 428a has an optical axis 432a aligned with a corresponding one of the at least four light redirecting surfaces of the optical component 450a. Each of the at least four cameras 428a has a lens assembly 224, 226 positioned to receive light representing one of the plurality of partial images of the target scene redirected from the corresponding one of the at least four light redirecting surfaces. Each of the at least four cameras 428a has an image sensor 232, 234 that receives the light after passing of the light through the lens assembly 224, 226. A virtual optical axis 466a passing through the optical component 450a, a point of intersection of the optical axis 420a of at least two of the at least four cameras 428a located on the virtual optical axis 466a.

Cooperation of the at least four cameras 428a forms a virtual camera 430a having the virtual optical axis 466a. The imaging system also includes a processing module configured to assemble the plurality of partial images into a final image of the target scene. The optical component 450a and each of the at least four cameras 428a are arranged within a camera housing having a height 412a of less than or equal to approximately 4.5 mm. A first set of the at least four cameras 428a cooperate to form a central virtual camera 430a having a first field of view and a second set of the at least four cameras 428a are arranged to each capture a portion of a second field of view. The second field of view includes portions of the target scene that are outside of the first field of view. The imaging system includes a processing module configured to combine images captured of the second field of view by the second set of the at least four cameras 428a with images captured of the first field of view by the first set of the at least four cameras 428a to form a final image of the target scene. The first set includes four cameras 428a and the second set includes four additional cameras 428a, and wherein the optical component 450a comprises eight light redirecting surfaces. The imaging system includes a substantially flat substrate, wherein each of the image sensors are positioned on the substrate or inset into a portion of the substrate. The imaging system includes, for each of the at least four cameras 428a, a secondary light redirecting surface configured to receive light from the lens assembly 224, 226 and redirect the light toward the image sensor 232, 234. The secondary light redirecting surface comprises a reflective or refractive surface. A size or position of one of the at least four light redirecting surfaces 450a is configured as a stop limiting the amount of light provided to a corresponding one of the at least four cameras 428a. The imaging system includes an aperture, wherein light from the target scene passes through the aperture onto the at least four light redirecting surfaces 450a.

Angles f1-2 each represent half of the virtual field of view of the camera 428. The combined virtual field of view of the camera 428 is the sum of angles f1-2, which is 30 degrees for this example.

Angle j represents the angle between the plane parallel to the virtual entrance pupil plane 460 at a location where the actual field of view of the camera 428 intersects the reflective surface 450, which is represented as plane 464, and a first edge 468 of the actual field of view of the camera 428. Here, angle j is 37.5 degrees.

TABLE 1B
Inputs

| | | |
|---|---|---|
| (Distance 412) | 4 | mm |
| z | 0 | deg |
| f1-2 | 15 | deg |
| j | 37.5 | deg |

The output parameters will now be described. Angle j of the output parameters shown in Table 2B is the same as angle j of the input parameters shown in Table 1B. Angle b represents the angle between the optical axis 466 of the schematic 410 and the back side of the reflective surface 450. Angle h represents the angle between the virtual entrance pupil plane 460 and one edge (the downward projected edge of the camera 428) of the actual field of view of the camera 428.

Distance 412 is described above with respect to the input parameters of Table 1B. Distance 472 represents the distance of half of the field of view at a plane extending between a terminal end 452 of the reflective surface 450 and the edge 466 of the virtual field of view of the camera 428 such that the measured Distance 472 is perpendicular to the optical axis 434 of the virtual field of view of the camera 428. Distance 424a-b represents half the distance between the entrance pupil of the camera 428 and the virtual entrance pupil 420. Distance 418 represents the distance between the virtual entrance pupil plane 460 and the plane of the entrance pupil of the camera 428, which is parallel to the virtual entrance pupil plane 460. Distance 416 represents the shortest distance between the plane perpendicular to the virtual entrance pupil plane 460, which is represented as plane 466, and the entrance pupil of the camera 428.

Angle e represents the angle between the optical axis 434 of the virtual field of view for the camera 428 and the back side of the reflective surface 450. Angle c represents the angle between the optical axis 434 of the virtual field of view for the camera 428 and the front side of the reflective surface 450. Angle d represents the angle between the front side of the reflective surface 450 and the optical axis 432 of the actual field of view for the camera 428. Angle a represents the angle between the optical axis of the projected actual field of view for a camera opposite the camera 428 and the optical axis 432 of the projected actual field of view for the camera 428.

Point 422 is the location where the optical axis 432 of the actual field of view for the camera 428 intersects the optical axis 434 of the virtual field of view for the camera 428. The virtual field of view for the camera 428 is as if the camera 428 were “looking” from a position at the virtual entrance pupil 420 along the optical axis 434. However, the actual field of view for the camera 428 is directed from the actual entrance pupil of the camera 428 along the optical axis 432. Although the actual field of view of the camera 428 is directed in the above direction, the camera 428 captures the incoming light from the virtual field of view as a result of the incoming light being redirected from the reflective surface 450 towards the actual entrance pupil of the camera 428.

TABLE 2B
Outputs

| | | | |
|---|---|---|---|
| j | 37.5 | | deg |
| b | −52.5 | = −90 + j | deg |
| h | 60 | = 90 − (z + 2 * f1-2) | deg |
| (Distance 412) | 4 | = (Distance 412)/cos(z) | mm |
| (Distance 472) | 0 | = (Distance 412) * sin(z) | mm |
| (Distance 424a-b) | 2.435045716 | = (Distance 412) * | mm |
| | | cos(2 * f1-2 − j + h) | |
| (Distance 418) | 2.96472382 | = 2 * (Distance 424a-b) * | mm |
| | | sin(j) | |
| (Distance 416) | 3.863703305 | = 2 * (Distance 424a-b) * | mm |
| | | cos(j) | |
| e | 52.5 | = 90 − (f1-2 + h − j) | deg |
| c | 52.5 | = e | deg |
| d | 52.5 | = c | deg |
| a | 180 | = 180 − | deg |
| | | (180 − (f1-2 + h + d + e) | |

FIG. 3B illustrates a schematic of two cameras 428b, 430b of an embodiment of a multiple camera configuration 410b. FIG. 3B also represents a model upon which many different parallax free or substantially parallax free multi-camera embodiments can be conceived of, designed, and/or realized using methods presented herein. Table 3 provides equations used to determine the distances and angles shown in FIG. 1B based on the length 412_{b} and angles g₂, f₂ and k₂.

TABLE 3
Inputs

| | | |
|---|---|---|
| (Distance 412_{b}) | 4 | mm |
| g₂ | 22.5 | deg |
| f₂ | 22.5 | deg |
| k₂ | 0 | deg |

Outputs

| | | | |
|---|---|---|---|
| u1 | 0 | = k₂ | deg |
| u2 | −90 | = −90 + u1 | deg |
| j₂ | 22.5 | = 90 − (g₂ + 2 * f₂) | deg |
| (Distance 434_{b}) | 4.329568801 | = (Distance 412_{b})/cos(g₂) | mm |
| (Distance 455_{b}) | 1.656854249 | = (Distance 434_{b}) * sin(g₂) | mm |
| (Distance 460_{b}) | 1.656854249 | = (Distance 434_{b}) * | mm |
| | | cos(2 * f₂ − u1 + j₂) | |
| (Distance 418_{b}) | 0 | = 2 * (Distance 460_{b}) * | mm |
| | | sin(u1) | |
| (Distance 416_{b}) | 3.313708499 | = 2 * (Distance 460_{b}) * | mm |
| | | cos(u1) | |
| e₂ | 45 | = 90 − (f₂ + j₂ − u1) | deg |
| c₂ | 45 | = e₂ | deg |
| d₂ | 45 | = c₂ | deg |
| q₂ | 135 | = 180 − (180 − | deg |
| | | (f₂ + j₂ + d₂ + e₂)) | |

In FIG. 3B, the angles and distances of Table 3 are illustrated. The central camera 430b and side camera 428b are shown. The entrance pupil of the side camera 428b is offset from the virtual entrance pupil 420b according to Distance 416_{b} and Distance 418_{b}. Distance 416_{b} represents the distance between the optical axis 472_{b} and the entrance pupil center point of the side camera 428_{b}, where the distance 416b is measured perpendicular to the optical axis 472_{b}.

Distance 418_{b} represents the distance between the plane 460_{b} and a plane containing the entrance pupil center point of the side camera 428_{b} and is parallel to plane 460_{b}.

The remaining distances and angles can be found in Table 3 and are illustrated in FIG. 3B.

Table 3 provides the angle k₂ of the light redirecting surface 450_{b} with respect to a point intersecting point 437 and perpendicular to line 460_{b}. Point 437 is located on a plane perpendicular to the plane of the page showing FIG. 3B and hence perpendicular to the multi-camera system optical axis 472_{b}, and is at a distance 412_{b} from the line 460_{b}. The field of view of camera 430_{b} is shown by the two intersecting lines labeled 434_{b} where these two lines intersect at the center point of the entrance pupil of camera 430_{b}. The half angle field of view of camera 430_{b} is g₂ between the multi-camera optical axis 472_{b} and the field of view edge 434_{b}.

As shown in FIG. 3B camera 430_{b} has its optical axis coinciding with line 472_{b}. The half angle field of view of camera 428_{b} is f₂ with respect to camera 428_{b} optical axis 435_{b}. The optical axis of the virtual camera for camera 428_{b} is shown being redirected off of light redirecting surface 450_{b}. Assuming the light redirecting surface 450_{b} is perfectly flat and is a plane surface perpendicular to the plane of the page FIG. 3B is shown on and further assume the light redirecting planar surface fully covers the circular field of view of camera 428_{b}. As shown in FIG. 3B, the optical axis 435_{b} intersects at a point on the planar light redirecting surface 450_{b}. Suppose now a ray of light is traveling from a point in the object space along the virtual cameras optical axis 435_{b}. If there are now obstructions it will intercept the light redirecting surface and reflect off the planar light redirecting surface 450_{b} and travel along the optical axis 435_{b} of the camera 428_{b}. The angles c₂ and d₂ will be equal based on the principles and theories of optics. And hence the angle e₂ will equal c₂. From this we can show the planar light redirecting surface 450_{b} will intersect perpendicularly the line going from the entrance pupil center point of camera 430_{b} to the entrance pupil center point of camera 428_{b}. Hence the two line lengths 460_{b} can be shown to be equally distant.

It is possible the planar light redirecting surface 450_{b} covers only part of the field of view of camera 428_{b}. In this case not all the rays that travel from the object space towards the virtual camera entrance pupil that contains at its center the point 420_{b}, as shown in FIG. 3B, will reflect off the planar portion of a the light redirecting surface 450_{b} that partially covers the field of view of camera 428_{b}. From this perspective it is important to keep in mind camera 428_{b} has a field of view defined by half angel field of view f₂, the optical axis 435_{b} and the location of its entrance pupil as described by lengths 416_{b} and 418_{b}. Within this field of view a surface such as the light reflecting planar portion of the light redirecting surface 450_{b} may be partially in its field of view. The light rays traveling from the object space toward the entrance pupil of the virtual camera of camera 428_{b} and reflect off the planar portion of light redirecting surface 450_{b} will travel onto the entrance pupil of camera 428_{b} provided the planar portion of light redirecting surface 450_{b} and cameras 430_{b}and 428_{b} are positioned as shown in FIG. 3B, the equations of Table 3 and in accordance with the selected input values 412_{b}, g₂, f₂ and k₂.

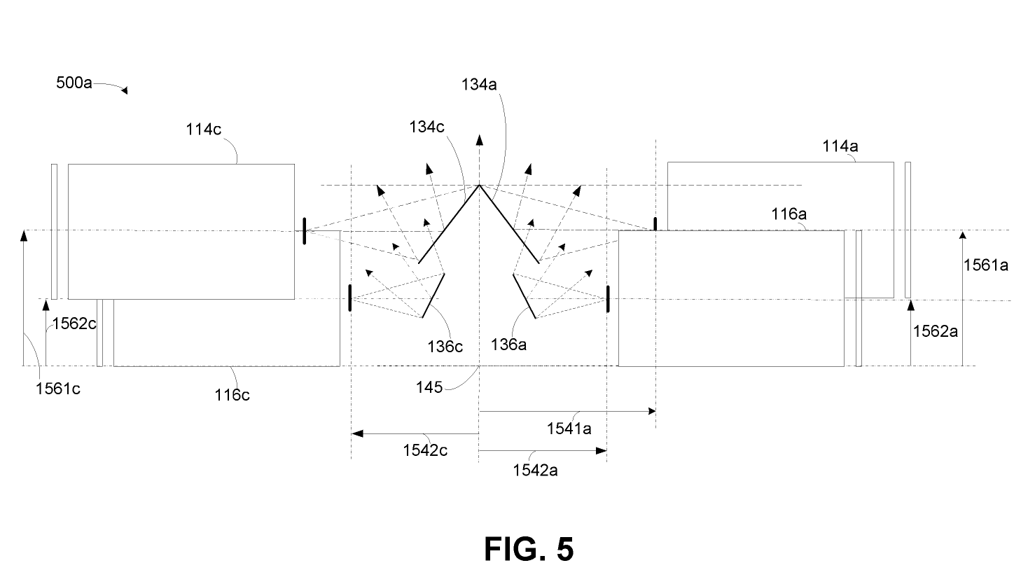

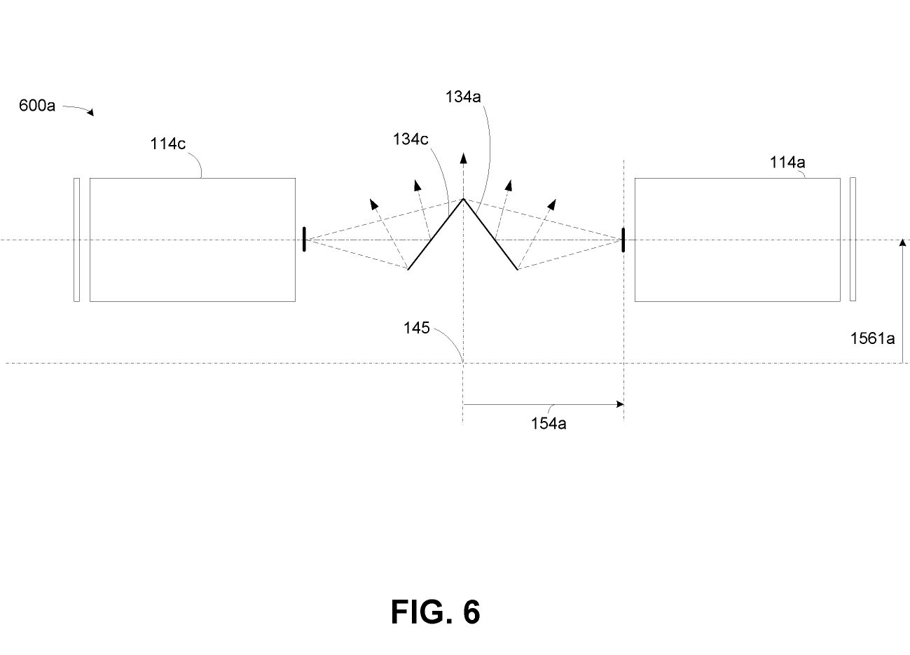

FIG. 4 illustrates an embodiment of a camera 20 shown in FIGS. 1A to 2B and 5-6. As shown in FIG. 4 the center most point of the entrance pupil 14 is located on the optical axis 19 and at where the vertex of the Field of View (FoV) 16 intersects the optical axis 19. The embodiment of camera 20 is shown throughout FIGS. 1 to 2B and shown in FIGS. 5 and 6 as cameras 114a-d and 116a-d. The front portion of the camera 20 is represented as a short bar 15. The plane contains the entrance pupil and point 14 is located on the front of 15. The front of the camera and the location of the entrance pupil is symbolized by 15. The short bar 15 sometimes may be shown as a narrow rectangle box or as a line in FIGS. 1 to 6. The center of the camera system 20 is the optics section 12, symbolizing the optical components used in the camera system 20. The image capture device is symbolized by 17 at the back of the camera system. The image capture device and or devices are further described herein. In FIGS. 1A to 2B and in FIGS. 5 and 6, the entire assembly of a the camera system represented by 20 in FIG. 4 may be pointed at by using a straight or curved arrow line and a reference number near the arrow line.

Angle designations are illustrated below the camera 20. Positive angles are designated by a circular line pointing in a counterclockwise direction. Negative angles are designated by a circular line pointing in a clockwise direction. Angles that are always positive are designated by a circular line that has arrows pointing in both the clockwise and counterclockwise directions. The Cartesian coordinate system is shown with the positive horizontal direction X going from left to right and the positive vertical direction Y going from the bottom to top.

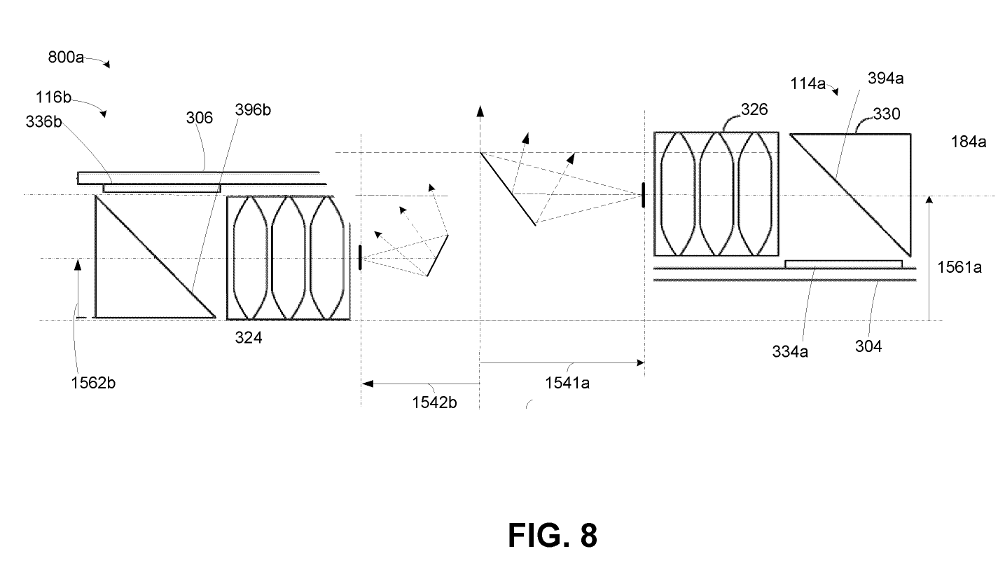

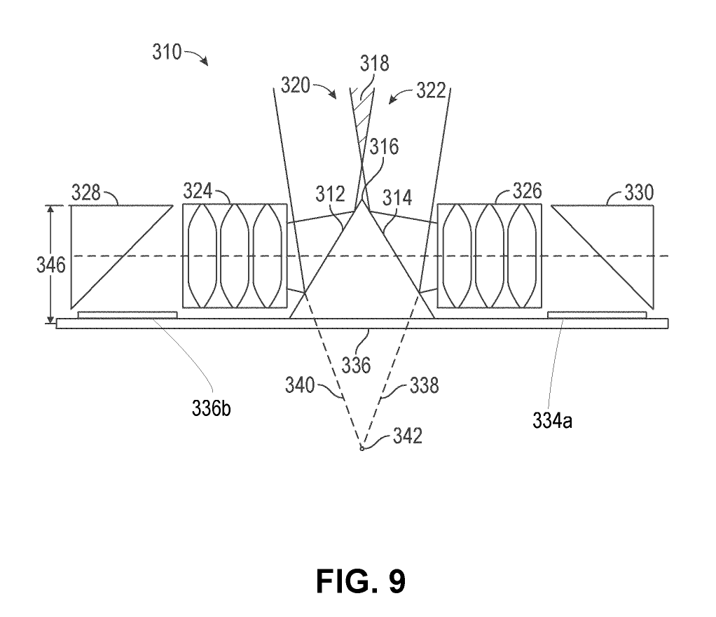

The image sensors of each camera, as shown as 17 in FIG. 4, and represented as part of the cameras 112, 114a-d and 116a-d as shown throughout the FIGS. 1-6, in FIG. 8 and FIG. 9 as 336a-d 334a-d may include, in certain embodiments, a charge-coupled device (CCD), complementary metal oxide semiconductor sensor (CMOS), or any other image sensing device that receives light and generates image data in response to the received image. Each image sensor of cameras 112, 114a-d, 116a-d and or of more concentric rings of cameras may include a plurality of sensors (or sensor elements) arranged in an array. Image sensors 17 as shown in FIG. 4 and represented in FIGS. 1A-6 and 8 and 9 can generate image data for still photographs and can also generate image data for a captured video stream. Image sensors 17 as shown in FIG. 4 and represented in FIGS. 1A-6 and 8 and 9 may be an individual sensor array, or each may represent arrays of sensors arrays, for example, a 3×1 array of sensor arrays. However, as will be understood by one skilled in the art, any suitable array of sensors may be used in the disclosed implementations.

Image sensors 17 as shown in FIG. 4 and represented in FIGS. 1A-6 and 8 and 9 may be mounted on the substrate as shown in FIG. 8 as 304 and 306 or one more substrates. In some embodiments, all sensors may be on one plane by being mounted to the flat substrate, shown as an example in FIG. 9 for substrate 336. Substrate 336, as shown in FIG. 9, may be any suitable substantially flat material. The central reflective element 316 and lens assemblies 324, 326 may be mounted on substrate 336 as well. Multiple configurations are possible for mounting a sensor array or arrays, a plurality of lens assemblies, and a plurality of primary and secondary reflective or refractive surfaces.

In some embodiments, a central reflective element 316 may be used to redirect light from a target image scene toward the sensors 336a-d, 334a-d. Central reflective element 316 may be a reflective surface (e.g., a mirror) or a plurality of reflective surfaces (e.g., mirrors), and may be flat or shaped as needed to properly redirect incoming light to the image sensors 336a-d, 334a-d. For example, in some embodiments, central reflective element 316 may be a mirror sized and shaped to reflect incoming light rays through the lens assemblies 324, 326 to sensors 332a-d, 334a-d. The central reflective element 316 may split light comprising the target image into multiple portions and direct each portion at a different sensor. For example, a first reflective surface 312 of the central reflective element 316 (also referred to as a primary light folding surface, as other embodiments may implement a refractive prism rather than a reflective surface) may send a portion of the light corresponding to a first field of view 320 toward the first (left) sensor 334a while a second reflective surface 314 sends a second portion of the light corresponding to a second field of view 322 toward the second (right) sensor 334a. It should be appreciated that together the fields of view 320, 322 of the image sensors 336a-d, 334a-d, cover at least the target image.

In some embodiments in which the receiving sensors are each an array of a plurality of sensors, the central reflective element may be made of multiple reflective surfaces angled relative to one another in order to send a different portion of the target image scene toward each of the sensors. Each sensor in the array may have a substantially different field of view, and in some embodiments the fields of view may overlap. Certain embodiments of the central reflective element may have complicated non-planar surfaces to increase the degrees of freedom when designing the lens system. Further, although the central element is discussed as being a reflective surface, in other embodiments central element may be refractive. For example, central element may be a prism configured with a plurality of facets, where each facet directs a portion of the light comprising the scene toward one of the sensors.

After being reflected off the central reflective element 316, at least a portion of incoming light may propagate through each of the lens assemblies 324, 326. One or more lens assemblies 324, 326 may be provided between the central reflective element 316 and the sensors 336a-d, 334a-d, and reflective surfaces 328, 330. The lens assemblies 324, 326 may be used to focus the portion of the target image which is directed toward each sensor 336a-d, 334a-d.

In some embodiments, each lens assembly may comprise one or more lenses and an actuator for moving the lens among a plurality of different lens positions. The actuator may be a voice coil motor (VCM), micro-electronic mechanical system (MEMS), or a shape memory alloy (SMA). The lens assembly may further comprise a lens driver for controlling the actuator.

In some embodiments, traditional auto focus techniques may be implemented by changing the focal length between the lens 324, 326 and corresponding sensors 336a-d, 334a-d, of each camera. In some embodiments, this may be accomplished by moving a lens barrel. Other embodiments may adjust the focus by moving the central light redirecting reflective mirror surface up or down or by adjusting the angle of the light redirecting reflective mirror surface relative to the lens assembly. Certain embodiments may adjust the focus by moving the side light redirecting reflective mirror surfaces over each sensor. Such embodiments may allow the assembly to adjust the focus of each sensor individually. Further, it is possible for some embodiments to change the focus of the entire assembly at once, for example by placing a lens like a liquid lens over the entire assembly. In certain implementations, computational photography may be used to change the focal point of the camera array.

Fields of view 320, 322 provide the folded optic multi-sensor assembly 310 with a virtual field of view perceived from a virtual region 342 where the virtual field of view is defined by virtual axes 338, 340. Virtual region 342 is the region at which sensors 336a-d, 334a-d, perceive and are sensitive to the incoming light of the target image. The virtual field of view should be contrasted with an actual field of view. An actual field of view is the angle at which a detector is sensitive to incoming light. An actual field of view is different from a virtual field of view in that the virtual field of view is a perceived angle from which incoming light never actually reaches. For example, in FIG. 3, the incoming light never reaches virtual region 342 because the incoming light is reflected off reflective surfaces 312, 314.

Multiple side reflective surfaces, for example, reflective surfaces 328 and 330, can be provided around the central reflective element 316 opposite the sensors. After passing through the lens assemblies, the side reflective surfaces 328, 330 (also referred to as a secondary light folding surface, as other embodiments may implement a refractive prism rather than a reflective surface) can reflect the light (downward, as depicted in the orientation of FIG. 3) onto the sensors 336a-d, 334a-d. As depicted, sensor 336b may be positioned beneath reflective surface 328 and sensor 334a may be positioned beneath reflective surface 330. However, in other embodiments, the sensors may be above the side reflected surfaces, and the side reflective surfaces may be configured to reflect light upward. Other suitable configurations of the side reflective surfaces and the sensors are possible in which the light from each lens assembly is redirected toward the sensors. Certain embodiments may enable movement of the side reflective surfaces 328, 330 to change the focus or field of view of the associated sensor.

Each sensor's field of view 320, 322 may be directed into the object space by the surface of the central reflective element 316 associated with that sensor. Mechanical methods may be employed to tilt the mirrors and/or move the prisms in the array so that the field of view of each camera can be directed to different locations on the object field. This may be used, for example, to implement a high dynamic range camera, to increase the resolution of the camera system, or to implement a plenoptic camera system. Each sensor's (or each 3×1 array's) field of view may be projected into the object space, and each sensor may capture a partial image comprising a portion of the target scene according to that sensor's field of view. As illustrated in FIG. 2B, in some embodiments, the fields of view 320, 322 for the opposing sensor arrays 336a-d, 334a-d, may overlap by a certain amount 318. To reduce the overlap 318 and form a single image, a stitching process as described below may be used to combine the images from the two opposing sensor arrays 336a-d, 334a-d. Certain embodiments of the stitching process may employ the overlap 318 for identifying common features in stitching the partial images together. After stitching the overlapping images together, the stitched image may be cropped to a desired aspect ratio, for example 4:3 or 1:1, to form the final image. In some embodiments, the alignment of the optical elements relating to each FOV are arranged to minimize the overlap 318 so that the multiple images are formed into a single image with minimal or no image processing required in joining the images.

### D. Overview of Further Example Four and Eight Camera Systems

FIG. 5 illustrates an embodiment of side view cross-section of the eight camera system 500a. Entrance pupil locations for two of the cameras in each of the first and second ring are shown, and light rays reflecting off mirror surfaces 134a, 134c, 136a and 136c are shown. The entrance pupil of the camera 116a is vertically offset from the virtual entrance pupil center most point 145 according to Distance 1542a and Distance 1562a. The entrance pupil of the camera 114a is vertically offset from the virtual entrance pupil according to Distance 1541ₐ and Distance 1561ₐ. Likewise, the entrance pupil of the camera 116c is vertically offset from the virtual entrance pupil center most point 145 according to Distance 1542c and Distance 1562c. The entrance pupil of the camera 114c is vertically offset from the virtual entrance pupil according to Distance 1541_{c} and Distance 1561_{c}.

FIG. 6 illustrates an embodiment of a side view cross-section of the four camera system. The entrance pupil center most point of the camera 114a is vertically offset from the virtual entrance pupil according to Distance 1541ₐ and Distance 1561ₐ. Likewise, the entrance pupil center most point of the camera 114c is vertically offset from the virtual entrance pupil according to Distance 1541_{c} and Distance 1561_{c}.

FIG. 7A shows an example of the top view of a reflective element 160 that can be used as the multi mirror system 700a of FIG. 1A. FIG. 7A further illustrates 8 reflective surfaces 124a-d and 126a-d that can be used for surfaces 134a-d and 136a-d, respectively as shown in FIGS. 2A, 2B, 5, 6 and 8. Surfaces 134a-d are associated with cameras 114a-d and are higher than the mirrors 136a-d. Mirrors surfaces 136a-d are associated with cameras 116a-d. FIG. 5 provides a side view example for the top view shown in FIG. 7A. In FIG. 5 we show mirror surfaces 134a and 134c, which represent the example surfaces 124a and 124c shown in FIG. 1A and FIG. 7A. Likewise, surfaces 136a-d are associated with cameras 116a-d and are lower than the mirrors surfaces 134a-d as shown in FIGS. 2A, 2B, 5, 6 and 8. As shown in FIGS. 1A and 7A the mirror surfaces 124a-d are rotated 22.5 about the multi-camera system optical axis 113, where the optical axis 113 is not shown in FIGS. 1A and 7A but is shown in FIGS. 2A and 2B. In FIG. 7A, circles are shown around the mirror surfaces 124a-d and elliptical surfaces are shown around mirror surfaces 126a-d. The elliptical circles symbolize the tilt of the field of view covered by for example camera 116a taken together with its associated mirror 126a. The tilt of field of view for the camera mirror combination 116a and 136a, according to Tables 1 and 2 is greater than that for camera-mirror combination 114a and 134a camera mirror combination. The circles and ellipses around the mirror surfaces 124a-d and 126a-d, as shown in FIG. 7A, reflect the field of view of these camera mirror combinations. The overlapping regions represent an example of how the fields of view may over overlap. The overlap represents scene content that may be within the field of views of neighboring or other cameras in the multi-camera system.

In FIG. 5 we show mirror surfaces 134a and 134c, which represent the example surfaces 124a and 124c shown in FIG. 1A and FIG. 7A illustrates a reflective element 700a comprising a plurality of reflective surfaces (not shown separately). Each of the reflective surfaces can reflect light along optical axes such that each of corresponding cameras can capture a partial image comprising a portion of the target image according to each camera-mirror combination field of view. The full field of view of the final image is denoted by dashed line 170 after cropping. The shape of the cropped edge 170 represents a square image with an aspect ratio of 1:1. The cropped image 170 can be further cropped to form other aspect ratios.

The multi-camera system can use such techniques as tilting the mirrors to point the optical axis of each camera-mirror combination in different directions than that used for the examples of FIGS. 2A and 2B and Tables 1 and 2. Using methods such as these may enable an arrangement that may produce overlapping patterns that may be more suited for other aspect ratios than that of a 1:1 aspect ratio shown in FIGS. 1A and 7A.

The fields of view 124a-d and 126a-d may share overlapping regions. In this embodiment, the fields of view may overlap in certain regions with only one other field of view.

In other regions, fields of view may overlap more than one other field of view. The overlapping regions share the same or similar content when reflected toward the eight cameras. Because the overlapping regions share the same or similar content (e.g., incoming light), this content can be used by an image stitching module to output a target image. Using a stitching technique, the stitching module can output a target image to an image processor.

FIG. 7B illustrates a side view of an embodiment of a portion of an eight camera configuration 710. The embodiment of FIG. 7B shows a reflective element 730 for an eight camera configuration free of parallax and tilt artifacts. Reflective element 730 can have a plurality of reflective surfaces 712a-c. In the embodiment of FIG. 7, reflective surfaces 712a-c are in the shape of prisms. Reflective element 730 is disposed at or near the center of the eight camera configuration, and is configured to reflect a portion of incoming light to each of the eight cameras (three cameras 718a-c are illustrated in FIG. 7B for clarity of this illustration). In some embodiments the reflective element 730 may be comprised of one component having at least eight reflective surfaces. In some other embodiments, the reflective element 730 may comprise a plurality of individual components, each having at least one reflective surface. The multiple components of the reflective element 730 may be coupled together, coupled to another structure to set their position relative to each other, or both. The reflective surfaces 712a, 712b, 712c can be separated from one another to be their own distinct parts. In another embodiment, the reflective surfaces 712a, 712b, 712c can be joined together to form one reflective element 730.

In the illustrated embodiment, the portion of an eight camera configuration 710 has cameras 718a-c, each camera capturing a portion of a target image such that a plurality portions of a target image may be captured. Cameras 718a and 718c are at a same or substantially the same distance (or height) 732 from the base of reflective element 730. Camera 718b is at a different distance (or height) 734 as compared to the distance 732 of cameras 718a and 718c. As illustrated in FIG. 7, camera 718b is at a greater distance (or height) 734 from the base of reflective element 730 than that of cameras 718a and 718c. Positioning cameras 718a and 718c at a different distance from the base of reflective element 730 provides an advantage of capturing both a central field of view as well as a wide field of view. Reflective surface 712b, near the top region of reflective element 730, can reflect incoming light providing for a central field of view. Reflective surfaces 712a and 712c, near the base of reflective element 730, can reflect incoming light providing for a wide field of view.

Placing reflective surface 712b at a different angle than reflective surfaces 712a and 712c provides both a central field of view as well as a wide field of view. However, reflective surfaces 712a-c are not required to be placed at different distances or angles from the base of reflective element 730 to capture both a central field of view as well as a wide field of view.

Cameras 718a-c have optical axes 724a-c such that cameras 718a-c are capable of receiving a portion of incoming light reflected from reflective surfaces 712a-c to cameras 718a-c. In accordance with FIG. 1, similar techniques may be used for configuration 710 to capture a target image.

In another embodiment, an inner camera 718b creates a +/−21 degree image using a reflective surface 712. Outer cameras 718a and 718c use other reflective surfaces 712a and 712c, to create a solution where multiple portions of a target image are captured. In this example reflective surface 712b has a tilted square shape. This provides a good point spread function (PSF) when it is uniform. Reflective surfaces 712a and 712c cover more area than reflective surface 712b but do not have a symmetrical shape. The reflective surfaces act as stops when they are smaller than the camera entrance pupil.

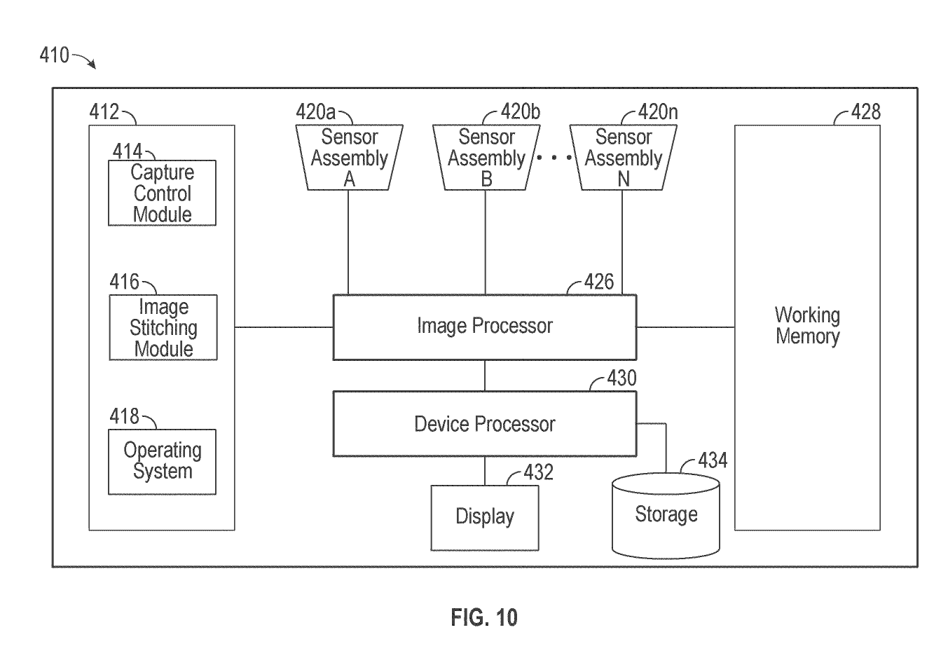

FIG. 8 illustrates a cross-sectional view of cameras 114a and 116b of FIG. 5 with a folded optics camera structure for each camera. As shown in FIG. 8, a folded optics array camera arrangement can be used where a light redirecting reflective mirror surface such as 394a and 396b may be used to redirect the light downward towards a sensor 334a and upward towards a sensor 336b. In the schematic representation shown in FIG. 8 the sensor 334a-d may be attached to one common substrate 304. Similarly, in the schematic representation shown in FIG. 8 the sensor 336a-d may be attached to one common substrate 306. The substrates 304 and 306 in this embodiment, as shown schematically in FIG. 8, may provide support and interconnections between the sensor 334a-d to the Sensor Assembly A 420a interface shown in FIG. 10, and similarly the interconnections between the sensors 336a-d the substrate 306 may provide support and interconnections between the sensors 336a-d and the Sensor Assembly B 420b. There may be other embodiments those skilled in the art that may be implemented in a different manner or by different technology. Greater or fewer concentric rings of cameras may be used in other embodiments, where if more are added the other sensor assembly interfaces 420c to 420n as shown in FIG. 10 may be used (sensor assembly interface 420c is not shown). The image sensors of the first set of array cameras may be disposed on a first substrate, the image sensors of the second set of array cameras may be disposed on a second and likewise form three or more substrates substrate. The substrate can be, for example, plastic, wood, etc. Further, in some embodiments the first, second or maybe more substrates may be disposed in planes that are parallel.

FIG. 9 illustrates a cross-sectional side view of an embodiment of a folded optic multi-sensor assembly. As illustrated in FIG. 9, the folded optic multi-sensor assembly 310 has a total height 346. In some embodiments, the total height 346 can be approximately 4.5 mm or less. In other embodiments, the total height 346 can be approximately 4.0 mm or less. Though not illustrated, the entire folded optic multi-sensor assembly 310 may be provided in a housing having a corresponding interior height of approximately more or less than 4.5 mm or less or approximately 4.0 mm or less.

The folded optic multi-sensor assembly 310 includes image sensors 332, 334, reflective secondary light folding surfaces 328, 330, lens assemblies 324, 326, and a central reflective element 316 which may all be mounted (or connected) to a substrate 336.

The image sensors 332, 334 may include, in certain embodiments, a charge-coupled device (CCD), complementary metal oxide semiconductor sensor (CMOS), or any other image sensing device that receives light and generates image data in response to the received image. Each sensor 332, 334 may include a plurality of sensors (or sensor elements) arranged in an array. Image sensors 332, 334 can generate image data for still photographs and can also generate image data for a captured video stream. Sensors 332 and 334 may be an individual sensor array, or each may represent arrays of sensors arrays, for example, a 3×1 array of sensor arrays. However, as will be understood by one skilled in the art, any suitable array of sensors may be used in the disclosed implementations.

The sensors 332, 334 may be mounted on the substrate 336 as shown in FIG. 9. In some embodiments, all sensors may be on one plane by being mounted to the flat substrate 336. Substrate 336 may be any suitable substantially flat material. The central reflective element 316 and lens assemblies 324, 326 may be mounted on substrate 336 as well. Multiple configurations are possible for mounting a sensor array or arrays, a plurality of lens assemblies, and a plurality of primary and secondary reflective or refractive surfaces.

In some embodiments, a central reflective element 316 may be used to redirect light from a target image scene toward the sensors 332, 334. Central reflective element 316 may be a reflective surface (e.g., a mirror) or a plurality of reflective surfaces (e.g., mirrors), and may be flat or shaped as needed to properly redirect incoming light to the image sensors 332, 334. For example, in some embodiments, central reflective element 316 may be a mirror sized and shaped to reflect incoming light rays through the lens assemblies 324, 326 to sensors 332, 334. The central reflective element 316 may split light comprising the target image into multiple portions and direct each portion at a different sensor. For example, a first reflective surface 312 of the central reflective element 316 (also referred to as a primary light folding surface, as other embodiments may implement a refractive prism rather than a reflective surface) may send a portion of the light corresponding to a first field of view 320 toward the first (left) sensor 332 while a second reflective surface 314 sends a second portion of the light corresponding to a second field of view 322 toward the second (right) sensor 334. It should be appreciated that together the fields of view 320, 322 of the image sensors 332, 334 cover at least the target image.

In some embodiments in which the receiving sensors are each an array of a plurality of sensors, the central reflective element may be made of multiple reflective surfaces angled relative to one another in order to send a different portion of the target image scene toward each of the sensors. Each sensor in the array may have a substantially different field of view, and in some embodiments the fields of view may overlap. Certain embodiments of the central reflective element may have complicated non-planar surfaces to increase the degrees of freedom when designing the lens system. Further, although the central element is discussed as being a reflective surface, in other embodiments central element may be refractive. For example, central element may be a prism configured with a plurality of facets, where each facet directs a portion of the light comprising the scene toward one of the sensors.

After being reflected off the central reflective element 316, at least a portion of incoming light may propagate through each of the lens assemblies 324, 326. One or more lens assemblies 324, 326 may be provided between the central reflective element 316 and the sensors 332, 334 and reflective surfaces 328, 330. The lens assemblies 324, 326 may be used to focus the portion of the target image which is directed toward each sensor 332, 334.

In some embodiments, each lens assembly may comprise one or more lenses and an actuator for moving the lens among a plurality of different lens positions. The actuator may be a voice coil motor (VCM), micro-electronic mechanical system (MEMS), or a shape memory alloy (SMA). The lens assembly may further comprise a lens driver for controlling the actuator.

In some embodiments, traditional auto focus techniques may be implemented by changing the focal length between the lens 324, 326 and corresponding sensors 332, 334 of each camera. In some embodiments, this may be accomplished by moving a lens barrel. Other embodiments may adjust the focus by moving the central light redirecting reflective mirror surface up or down or by adjusting the angle of the light redirecting reflective mirror surface relative to the lens assembly. Certain embodiments may adjust the focus by moving the side light redirecting reflective mirror surfaces over each sensor. Such embodiments may allow the assembly to adjust the focus of each sensor individually. Further, it is possible for some embodiments to change the focus of the entire assembly at once, for example by placing a lens like a liquid lens over the entire assembly. In certain implementations, computational photography may be used to change the focal point of the camera array.

Fields of view 320, 322 provide the folded optic multi-sensor assembly 310 with a virtual field of view perceived from a virtual region 342 where the virtual field of view is defined by virtual axes 338, 340. Virtual region 342 is the region at which sensors 332, 334 perceive and are sensitive to the incoming light of the target image. The virtual field of view should be contrasted with an actual field of view. An actual field of view is the angle at which a detector is sensitive to incoming light. An actual field of view is different from a virtual field of view in that the virtual field of view is a perceived angle from which incoming light never actually reaches. For example, in FIG. 9, the incoming light never reaches virtual region 342 because the incoming light is reflected off reflective surfaces 312, 314.

Multiple side reflective surfaces, for example, reflective surfaces 328 and 330, can be provided around the central reflective element 316 opposite the sensors. After passing through the lens assemblies, the side reflective surfaces 328, 330 (also referred to as a secondary light folding surface, as other embodiments may implement a refractive prism rather than a reflective surface) can reflect the light (downward, as depicted in the orientation of FIG. 9) onto the sensors 332, 334. As depicted, sensor 332 may be positioned beneath reflective surface 328 and sensor 334 may be positioned beneath reflective surface 330. However, in other embodiments, the sensors may be above the side reflected surfaces, and the side reflective surfaces may be configured to reflect light upward. Other suitable configurations of the side reflective surfaces and the sensors are possible in which the light from each lens assembly is redirected toward the sensors. Certain embodiments may enable movement of the side reflective surfaces 328, 330 to change the focus or field of view of the associated sensor.

Each sensor's field of view 320, 322 may be directed into the object space by the surface of the central reflective element 316 associated with that sensor. Mechanical methods may be employed to tilt the mirrors and/or move the prisms in the array so that the field of view of each camera can be directed to different locations on the object field. This may be used, for example, to implement a high dynamic range camera, to increase the resolution of the camera system, or to implement a plenoptic camera system. Each sensor's (or each 3×1 array's) field of view may be projected into the object space, and each sensor may capture a partial image comprising a portion of the target scene according to that sensor's field of view. As illustrated in FIG. 9, in some embodiments, the fields of view 320, 322 for the opposing sensor arrays 332, 334 may overlap by a certain amount 318. To reduce the overlap 318 and form a single image, a stitching process as described below may be used to combine the images from the two opposing sensor arrays 332, 334. Certain embodiments of the stitching process may employ the overlap 318 for identifying common features in stitching the partial images together. After stitching the overlapping images together, the stitched image may be cropped to a desired aspect ratio, for example 4:3 or 1:1, to form the final image. In some embodiments, the alignment of the optical elements relating to each FOV are arranged to minimize the overlap 318 so that the multiple images are formed into a single image with minimal or no image processing required in joining the images.

As illustrated in FIG. 9, the folded optic multi-sensor assembly 310 has a total height 346. In some embodiments, the total height 346 can be approximately 4.5 mm or less. In other embodiments, the total height 346 can be approximately 4.0 mm or less. Though not illustrated, the entire folded optic multi-sensor assembly 310 may be provided in a housing having a corresponding interior height of approximately 4.5 mm or less or approximately 4.0 mm or less.

As used herein, the term “camera” may refer to an image sensor, lens system, and a number of corresponding light folding surfaces; for example, the primary light folding surface 314, lens assembly 326, secondary light folding surface 330, and sensor 334 are illustrated in FIG. 9. A folded-optic multi-sensor assembly, referred to as an “array” or “array camera,” can include a plurality of such cameras in various configurations.

### E. Overview of Example Imaging System

FIG. 10 depicts a high-level block diagram of a device 410 having a set of components including an image processor 426 linked to one or more cameras 420a-n. The image processor 426 is also in communication with a working memory 428, memory component 412, and device processor 430, which in turn is in communication with storage 434 and electronic display 432.

Device 410 may be a cell phone, digital camera, tablet computer, personal digital assistant, or the like. There are many portable computing devices in which a reduced thickness imaging system such as is described herein would provide advantages. Device 410 may also be a stationary computing device or any device in which a thin imaging system would be advantageous. A plurality of applications may be available to the user on device 410. These applications may include traditional photographic and video applications, high dynamic range imaging, panoramic photo and video, or stereoscopic imaging such as 3D images or 3D video.

The image capture device 410 includes cameras 420a-n for capturing external images. Each of cameras 420a-n may comprise a sensor, lens assembly, and a primary and secondary reflective or refractive mirror surface for reflecting a portion of a target image to each sensor, as discussed above with respect to FIG. 3. In general, N cameras 420a-n may be used, where N 2. Thus, the target image may be split into N portions in which each sensor of the N cameras captures one portion of the target image according to that sensor's field of view. It will be understood that cameras 420a-n may comprise any number of cameras suitable for an implementation of the folded optic imaging device described herein. The number of sensors may be increased to achieve lower z-heights of the system or to meet the needs of other purposes, such as having overlapping fields of view similar to that of a plenoptic camera, which may enable the ability to adjust the focus of the image after post-processing. Other embodiments may have a field of view overlap configuration suitable for high dynamic range cameras enabling the ability to capture two simultaneous images and then merge them together. Cameras 420a-n may be coupled to the image processor 426 to communicate captured images to the working memory 428, the device processor 430, to the electronic display 432 and to the storage (memory) 434.

The image processor 426 may be configured to perform various processing operations on received image data comprising N portions of the target image in order to output a high quality stitched image, as will be described in more detail below. Image processor 426 may be a general purpose processing unit or a processor specially designed for imaging applications. Examples of image processing operations include cropping, scaling (e.g., to a different resolution), image stitching, image format conversion, color interpolation, color processing, image filtering (for example, spatial image filtering), lens artifact or defect correction, etc. Image processor 426 may, in some embodiments, comprise a plurality of processors. Certain embodiments may have a processor dedicated to each image sensor. Image processor 426 may be one or more dedicated image signal processors (ISPs) or a software implementation of a processor.

As shown, the image processor 426 is connected to a memory 412 and a working memory 428. In the illustrated embodiment, the memory 412 stores capture control module 414, image stitching module 416, operating system 418, and reflector control module 419. These modules include instructions that configure the image processor 426 of device processor 430 to perform various image processing and device management tasks. Working memory 428 may be used by image processor 426 to store a working set of processor instructions contained in the modules of memory component 412. Alternatively, working memory 428 may also be used by image processor 426 to store dynamic data created during the operation of device 410.

As mentioned above, the image processor 426 is configured by several modules stored in the memories. The capture control module 414 may include instructions that configure the image processor 426 to call reflector control module 419 to position the extendible reflectors of the camera in a first or second position, and may include instructions that configure the image processor 426 to adjust the focus position of cameras 420a-n. Capture control module 414 may further include instructions that control the overall image capture functions of the device 410. For example, capture control module 414 may include instructions that call subroutines to configure the image processor 426 to capture raw image data of a target image scene using the cameras 420a-n. Capture control module 414 may then call the image stitching module 416 to perform a stitching technique on the N partial images captured by the cameras 420a-n and output a stitched and cropped target image to imaging processor 426. Capture control module 414 may also call the image stitching module 416 to perform a stitching operation on raw image data in order to output a preview image of a scene to be captured, and to update the preview image at certain time intervals or when the scene in the raw image data changes.

Image stitching module 416 may comprise instructions that configure the image processor 426 to perform stitching and cropping techniques on captured image data. For example, each of the N sensors 420a-n may capture a partial image comprising a portion of the target image according to each sensor's field of view. The fields of view may share areas of overlap, as described above and below. In order to output a single target image, image stitching module 416 may configure the image processor 426 to combine the multiple N partial images to produce a high-resolution target image. Target image generation may occur through known image stitching techniques. Examples of image stitching can be found in U.S. patent application Ser. No. 11/623,050 which is hereby incorporated by reference.

For example, image stitching module 416 may include instructions to compare the areas of overlap along the edges of the N partial images for matching features in order to determine rotation and alignment of the N partial images relative to one another. Due to rotation of partial images and/or the shape of the field of view of each sensor, the combined image may form an irregular shape. Therefore, after aligning and combining the N partial images, the image stitching module 416 may call subroutines which configure image processor 426 to crop the combined image to a desired shape and aspect ratio, for example a 4:3 rectangle or 1:1 square. The cropped image may be sent to the device processor 430 for display on the display 432 or for saving in the storage 434.

Operating system module 418 configures the image processor 426 to manage the working memory 428 and the processing resources of device 410. For example, operating system module 418 may include device drivers to manage hardware resources such as the cameras 420a-n. Therefore, in some embodiments, instructions contained in the image processing modules discussed above may not interact with these hardware resources directly, but instead interact through standard subroutines or APIs located in operating system component 418. Instructions within operating system 418 may then interact directly with these hardware components. Operating system module 418 may further configure the image processor 426 to share information with device processor 430.

The image processor 426 can provide image capture mode selection controls to a user, for instance by using a touch-sensitive display 432, allowing the user of device 410 to select an image capture mode corresponding to either the standard FOV image or a wide FOV image.

Device processor 430 may be configured to control the display 432 to display the captured image, or a preview of the captured image, to a user. The display 432 may be external to the imaging device 410 or may be part of the imaging device 410. The display 432 may also be configured to provide a view finder displaying a preview image for a use prior to capturing an image, or may be configured to display a captured image stored in memory or recently captured by the user. The display 432 may comprise an LCD or LED screen, and may implement touch sensitive technologies.

Device processor 430 may write data to storage module 434, for example data representing captured images. While storage module 434 is represented graphically as a traditional disk device, those with skill in the art would understand that the storage module 434 may be configured as any storage media device. For example, the storage module 434 may include a disk drive, such as a floppy disk drive, hard disk drive, optical disk drive or magneto-optical disk drive, or a solid state memory such as a FLASH memory, RAM, ROM, and/or EEPROM. The storage module 434 can also include multiple memory units, and any one of the memory units may be configured to be within the image capture device 410, or may be external to the image capture device 410. For example, the storage module 434 may include a ROM memory containing system program instructions stored within the image capture device 410. The storage module 434 may also include memory cards or high speed memories configured to store captured images which may be removable from the camera.

Although FIG. 10 depicts a device having separate components to include a processor, imaging sensor, and memory, one skilled in the art would recognize that these separate components may be combined in a variety of ways to achieve particular design objectives. For example, in an alternative embodiment, the memory components may be combined with processor components to save cost and improve performance. Additionally, although FIG. 10 illustrates two memory components, including memory component 412 comprising several modules and a separate memory 428 comprising a working memory, one with skill in the art would recognize several embodiments utilizing different memory architectures. For example, a design may utilize ROM or static RAM memory for the storage of processor instructions implementing the modules contained in memory component 412. The processor instructions may be loaded into RAM to facilitate execution by the image processor 426. For example, working memory 428 may comprise RAM memory, with instructions loaded into working memory 428 before execution by the processor 426.

### F. Overview of Example Imaging Capture Process

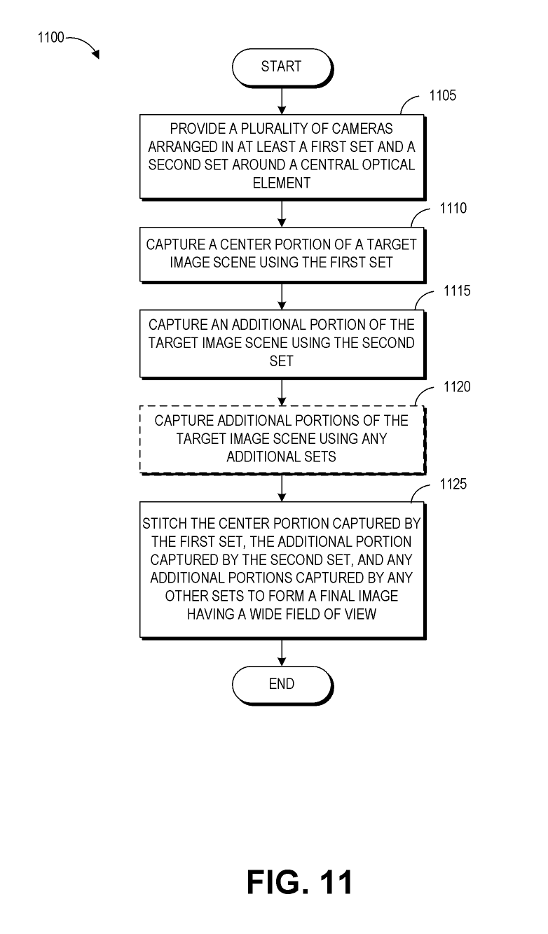

FIG. 11 illustrates blocks of one example of a method 1100 of capturing a wide field of view target image.

At block 1105, a plurality of cameras are provided and arranged in at least a first set and a second set around a central optical element, for example as illustrated in FIGS. 7A and 7B. In some embodiments, greater or fewer than the first and second set of cameras can be provided. For example, the four camera embodiment described herein can include only a first ring of cameras.

At block 1110, the imaging system captures a center portion of the target image scene using the first set of cameras. For example, this can be done using the first ring of cameras 114a-d.

At block 1115, the imaging system captures an additional portion of the target image scene using the second set of cameras. For example, this can be done using the second ring of cameras 116a-d. The additional portion of the target image scene can be, for example, a field of view or partial field of view surrounding the center portion.

At optional block 1120, the imaging system captures an additional portion of the target image scene using the second set of cameras. For example, this can be done using a third ring of cameras, such as may be provided in a 12 camera embodiment. The additional portion of the target image scene can be, for example, a field of view or partial field of view surrounding the center portion.

At block 1125, the center portion and any additional portions are received in at least one processor. A stitched image is generated by the at least one processor that includes at least a portion of the center image and additional portion(s). For example, the processor can stitch the center portion captured by the first set, the additional portion captured by the second set, and any additional portions captured by any other sets, and then crop the stitched image to a desired aspect ratio in order to form a final image having a wide field of view.

### G. Terminology

Implementations disclosed herein provide systems, methods and apparatus for multiple aperture array cameras free from parallax and tilt artifacts. One skilled in the art will recognize that these embodiments may be implemented in hardware, software, firmware, or any combination thereof.

In some embodiments, the circuits, processes, and systems discussed above may be utilized in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, a memory including instructions or modules for carrying out the CNR process discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

1. An imaging system, comprising:
an optical component comprising at least four light redirecting surfaces;
at least four cameras each configured to capture one of a plurality of partial images of a target scene, each of the at least four cameras having:
an optical axis aligned with a corresponding one of the at least four light redirecting surfaces of the optical component,
a lens assembly positioned to receive light representing one of the plurality of partial images of the target scene redirected from the corresponding one of the at least four light redirecting surfaces, and
an image sensor that receives the light after passing of the light through the lens assembly; and
a virtual optical axis passing through the optical component, a point of intersection of the optical axis of at least two of the at least four cameras located on the virtual optical axis.

2. The imaging system of claim 1, wherein cooperation of the at least four cameras forms a virtual camera having the virtual optical axis.

3. The imaging system of claim 1, further comprising a processing module configured to assemble the plurality of partial images into a final image of the target scene.

4. The imaging system of claim 1, wherein the optical component and each of the at least four cameras are arranged within a camera housing having a height of less than or equal to approximately 4.5 mm.

5. The imaging system of claim 1, wherein a first set of the at least four cameras cooperate to form a central virtual camera having a first field of view and a second set of the at least four cameras are arranged to each capture a portion of a second field of view, the second field of view including portions of the target scene that are outside of the first field of view.

6. The imaging system of claim 5, comprising a processing module configured to combine images captured of the second field of view by the second set of the at least four cameras with images captured of the first field of view by the first set of the at least four cameras to form a final image of the target scene.

7. The imaging system of claim 5, wherein the first set includes four cameras and the second set includes four additional cameras, and wherein the optical component comprises eight light redirecting surfaces.

8. The imaging system of claim 1, further comprising a substantially flat substrate, wherein each of the image sensors are positioned on the substrate or inset into a portion of the substrate.

9. The imaging system of claim 1, further comprising, for each of the at least four cameras, a secondary light redirecting surface configured to receive light from the lens assembly and redirect the light toward the image sensor.

10. The imaging system of claim 9, wherein the secondary light redirecting surface comprises a reflective or refractive surface.

11. The imaging system of claim 1, wherein a size or position of one of the at least four light redirecting surfaces is configured as a stop limiting the amount of light provided to a corresponding one of the at least four cameras.

12. The imaging system of claim 1, further comprising an aperture, wherein light from the target scene passes through the aperture onto the at least four light redirecting surfaces.

13. A method of capturing an image substantially free of parallax, comprising:
receiving light representing a target image scene through an aperture;
splitting the light into at least four portions via at least four light redirecting surfaces;
redirecting each portion of the light toward a corresponding camera of at least four cameras each positioned to capture image data from a location of a virtual camera having a virtual optical axis, an optical axis of each of the at least four cameras intersecting with the virtual optical axis; and
for each of the at least four cameras, capturing an image of a corresponding one of the at least four portions of the light at an image sensor.

14. The method of claim 13, wherein cooperation of the plurality of image sensors forms a virtual camera having the virtual optical axis.

15. The method of claim 13, further comprising assembling the images of each portion of the light into a final image.

16. The method of claim 13, wherein splitting the light into at least four portions comprises splitting the light into eight portions via four primary light redirecting surfaces corresponding to four primary cameras and via four additional light redirecting surfaces corresponding to four additional cameras, wherein the four primary cameras and four additional cameras cooperate to form the virtual camera.

17. The method of claim 13, wherein capturing the image of each portion of the light comprises capturing a first field of view of the target image scene using a first set of the at least four cameras and capturing a second field of view of the target image scene using a second set of the at least four cameras, wherein the second field of view includes portions of a target scene that are outside of the first field of view.

18. The method of claim 17, further comprising combining images captured of the second field of view by the second set of the at least four cameras with images captured of the first field of view by the first set of the at least four cameras to form a final image.

19. The method of claim 17, wherein the first set includes four cameras and the second set includes four cameras.

20. An imaging system, comprising:
means for redirecting light representing a target image scene in at least four directions;
a plurality of capturing means each having:
an optical axis aligned with a virtual optical axis of the imaging system and intersecting with a point common to at least one other optical axis of another of the capturing means,
focusing means positioned to receive, from the means for redirecting light, a portion of the light redirected in one of the at least four directions, and
image sensing means that receives the portion of the light from the focusing means;
means for receiving image data comprising, from each of the plurality of capturing means, an image captured of the portion of the light; and
means for assembling the image data into a final image of the target image scene.

21. The imaging system of claim 20, wherein cooperation of the plurality of capturing means forms a virtual camera having the virtual optical axis.

22. The imaging system of claim 20, wherein a first set of the capturing means are arranged to capture a first field of view and a second set of the capturing means are arranged to capture a second field of view, the second field of view including portions of the target scene that are outside of the first field of view.

23. The imaging system of claim 22, wherein the means for assembling the image data combines images of the second field of view with images of the first field of view to form the final image.

24. A method of manufacturing an imaging system, the method comprising:
providing an optical component comprising at least four light redirecting surfaces;
positioning at least four cameras around the optical component, each camera of the at least four cameras configured to capture one of a plurality of partial images of a target scene, wherein positioning the at least four cameras comprises, for each camera:
aligning an optical axis of the camera with a corresponding one of the at least four light redirecting surfaces of the optical component,
further positioning the camera such that the optical axis intersects at least one other optical axis of another of the at least four cameras at a point located along a virtual optical axis of the imaging system, and
providing an image sensor that captures one of the plurality of partial images of the target scene; and
positioning the optical component such that the virtual optical axis passes through the optical component.

25. The method of claim 24, wherein cooperation of the plurality of image cameras forms a virtual camera having the virtual optical axis.

26. The method of claim 24, further comprising positioning a first set of the at least four cameras and corresponding light redirecting surfaces to capture a first field of view and positioning a second set of the plurality of cameras and corresponding light redirecting surfaces to capture a second field of view, wherein the second field of view includes portions of the target scene that are outside of the first field of view.

27. The method of claim 24, further comprising providing a substantially flat substrate and, for each of the at least four cameras, positioning the image sensor on or inset into the substantially flat substrate.

28. The method of claim 24, further comprising, for each of the at least four cameras, providing a lens assembly between the image sensor and the optical component.

29. The method of claim 24, further comprising, for each of the at least four cameras, providing a reflective or refractive surface between the image sensor and the optical component.

30. The system of claim 24, further comprising configuring at least one of the at least four light redirecting surfaces as a stop limiting the amount of light provided to a corresponding image sensor.
